(19) United States
(12) Patent Application Publication
(10) Pub. No.: US 2020/0026128 A1
(43) Pub. Date: Jan. 23, 2020

(54) LIQUID CRYSTAL DISPLAY DEVICE AND METHOD FOR MANUFACTURING LIQUID CRYSTAL DISPLAY DEVICE

(71) Applicant: SHARP KABUSHIKI KAISHA, Sakai City (JP)

(72) Inventors: MASANOBU MIZUSAKI, Sakai City (JP); TOMONORI ITOH, Sakai City (JP)

(21) Appl. No.: 16/505,607

(22) Filed: Jul. 8, 2019

Related U.S. Application Data
(60) Provisional application No. 62/702,133, filed on Jul. 23, 2018.

(51) Int. Cl. G02F 1/1337; C08L 79/08

(52) U.S. Cl. CPC G02F 1/133723; C08L 79/08

(57) ABSTRACT

The present invention provides a liquid crystal display device that includes: a pair of substrates; a liquid crystal layer held between the substrates; and an alignment film disposed on a liquid crystal layer side surface of at least one of the substrates, the liquid crystal layer containing a liquid crystal material that has a nematic-isotropic phase transition temperature of 75° C. or lower and a nematic phase temperature range narrower than 100° C., the alignment film containing a first polymer and a second polymer, the first polymer having in its main chain at least one selected from a polyamic acid structure and a polyimide structure or a polysiloxane structure, the second polymer being obtained by polymerizing at least one monomer including at least one monomer containing an azobenzene group.

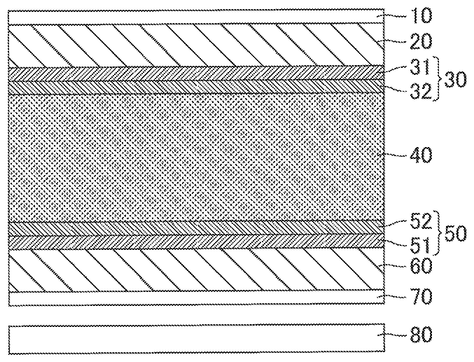

### CROSS-REFERENCE TO RELATED APPLICATIONS

The present application claims priority under 35 U.S.C. 5119 to U.S. Provisional Patent Application No. 62/702,133 filed on Jul. 23, 2018, the contents of which are incorporated herein by reference in their entirety.

### BACKGROUND OF THE INVENTION

### Field of the Invention

The present invention relates to liquid crystal display devices and methods for manufacturing a liquid crystal display device. The present invention specifically relates to a liquid crystal display device and a manufacture method thereof which are suitable for head mounted displays (HMDs).

### Description of Related Art

Displays such as liquid crystal display devices have spread rapidly and have been used in a wide variety of applications including televisions, electronic book readers, digital photo frames, industrial appliances, personal computers (PCs), tablet PCs, smartphones, and HMDs. Liquid crystal display devices are required to have a variety of properties in these applications, and thus a variety of liquid crystal display modes have been developed.

For example, WO 2010/026721 discloses a technique to improve the alignment stability of liquid crystal, which includes introducing a bifunctional monomer into a photo-alignment film for a 4D-RTN mode to cause thermal polymerization.

### BRIEF SUMMARY OF THE INVENTION

With the photo-alignment techniques for horizontal alignment and vertical alignment modes, the voltage holding ratio decreases with time as the device is exposed to backlight illumination. Meanwhile, the viscosity of the liquid crystal material is reduced for use in head mounted display (HMD) applications because the applications require rapid response. This, however, involves an issue that the liquid crystal material becomes undesirably likely to crystallize (solidify) at low temperatures. The causes of these undesirable changes are described below.

Cold cathode fluorescent lamp (CCFL) backlights emit ultraviolet light having a wavelength of about 370 nm or longer. Light emitting diode (LED) backlights are also found to emit similar light. Irradiating a liquid crystal cell with ultraviolet light deteriorates the liquid crystal material therein, generating ionic or radical impurities. Also, in order to achieve a rapid response of a liquid crystal display device, the viscosity of the liquid crystal material therein needs to be low. One effective way to reduce the viscosity of the liquid crystal material is to set the liquid crystal (nematic) phase temperature range of the liquid crystal material to the narrowest, which means to lower the liquid crystal (nematic)-isotropic phase transition temperature (Tni) and increase the solid (crystalline)-liquid crystal (nematic) phase transition temperature to the highest possible. Specifically, the viscosity in a liquid crystal display device for HMDs is reduced by setting the liquid crystal (nematic) phase temperature range to narrower than 100° C., with the LCD use temperature (20° C.) included as the center. In order to reduce the viscosity of the liquid crystal material, the molecular weight of liquid crystal compounds therein is brought to the minimum possible. Reduction in molecular weight, however, is likely to cause crystallization (solidification) of the liquid crystal material at low temperatures. One possible cause of the crystallization is the strong intermolecular interaction between the liquid crystal compounds in the liquid crystal material.

There has been also a demand for contrast ratio increase in horizontal electric field modes such as the in-plane switching (IPS) mode and the fringe field switching (FFS) mode. For an increase in contrast ratio, photo-alignment is more advantageous than rubbing because photo-alignment can control liquid crystal molecules in one direction with a higher degree of precision than rubbing. Liquid crystal molecules, however, exhibit stronger interaction between them as they are aligned with a higher degree of precision, which is likely to be a cause of crystallization at low temperatures. A common conventional photo-alignment film includes two layers, namely a base polymer layer with no photo-functional group and a polymer layer with a photo-functional group.

In response to the above issues, an object of the present invention is to provide a liquid crystal display device that can reduce crystallization of a liquid crystal material at low temperatures and maintain a favorable voltage holding ratio for a long period of time in exposure to backlight illumination; and a method for manufacturing a liquid crystal display device, which enables manufacture of the above liquid crystal display device.

(1) One aspect of the present invention is directed to a liquid crystal display device including: a pair of substrates; a liquid crystal layer held between the substrates; and an alignment film disposed on a liquid crystal layer side surface of at least one of the substrates, the alignment film containing a first polymer and a second polymer, the first polymer having in its main chain at least one selected from a polyamic acid structure and a polyimide structure or a polysiloxane structure, the second polymer being obtained by polymerizing at least one monomer including at least one monomer represented by the following formula (1):

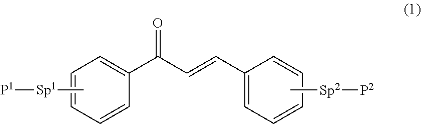

wherein P¹ and P² are the same as or different from each other, and each represent an acryloyloxy, methacryloyloxy, acryloylamino, methacryloylamino, vinyl, or vinyloxy group, Sp¹ and Sp² are the same as or different from each other, and each represent a C1-C10 linear, branched, or cyclic alkylene or alkenylene group, or a direct bond, L¹ and L² are the same as or different from each other, and each represent a —NH— group, a —N(CH₃)— group, a —O— group, a —S— group, or a direct bond, and at least one hydrogen atom in each phenylene group is optionally replaced.

(2) In an embodiment of the present invention, the liquid crystal display device includes the structure (1), and the at least one monomer represented by the formula (1) includes at least one monomer represented by any of the following formulas (2-1) to (2-17).

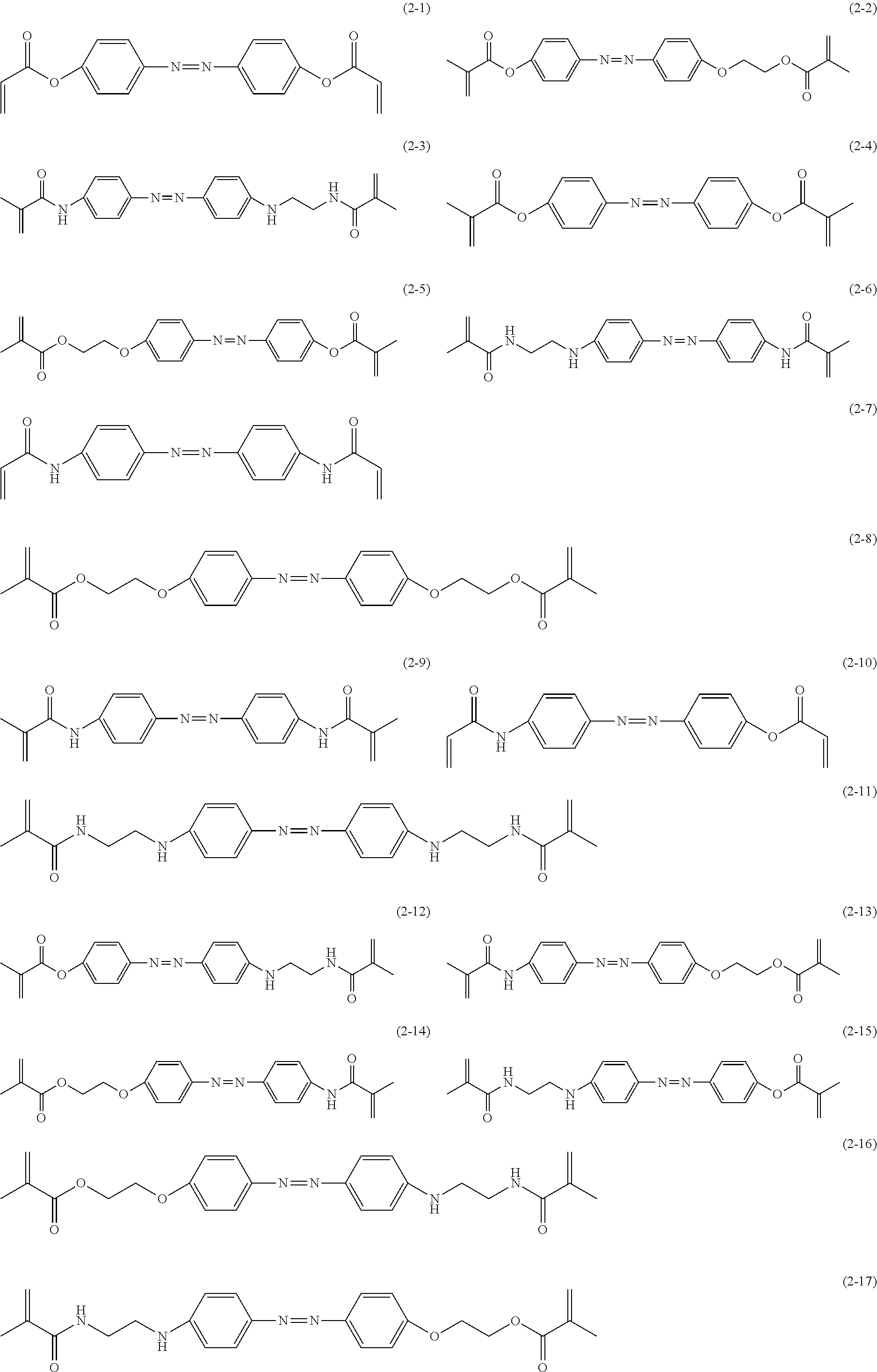

(3) In an embodiment of the present invention, the liquid crystal display device includes the structure (1) or (2), and the first polymer contains at least one photo-functional group selected from the group consisting of a cinnamate group, an azobenzene structure, a chalcone group, and a coumarin group, each of which may contain a substituent.

(4) In an embodiment of the present invention, the liquid crystal display device includes the structure (1), (2), or (3), and the alignment film includes a lower layer containing the first polymer and an upper layer disposed on a liquid crystal layer side of the lower layer and containing the second polymer.

(5) In an embodiment of the present invention, the liquid crystal display device includes the structure (4), and the lower layer is a photo-alignment layer.

(6) In an embodiment of the present invention, the liquid crystal display device includes the structure (4) or (5), and the lower layer is a vertical alignment layer.

(7) In an embodiment of the present invention, the liquid crystal display device includes the structure (4) or (5), and the lower layer is a horizontal alignment layer.

(8) In an embodiment of the present invention, the liquid crystal display device includes the structure (1), (2), (3), (4), (5), (6), or (7), and the liquid crystal layer contains a liquid crystal material that has a nematic-isotropic phase transition temperature of 75° C. or lower and a nematic phase temperature range narrower than 100° C.

(9) In an embodiment of the present invention, the liquid crystal display device includes the structure (1), (2), (3), (4), (5), (6), (7), or (8), and the liquid crystal layer contains a liquid crystal material containing 7 wt % or more of a liquid crystal compound containing an alkenyl group.

(10) In an embodiment of the present invention, the liquid crystal display device includes the structure (9), and the liquid crystal compound containing an alkenyl group includes at least one liquid crystal compound represented by any of the following formulas (D-1) to (D-4):

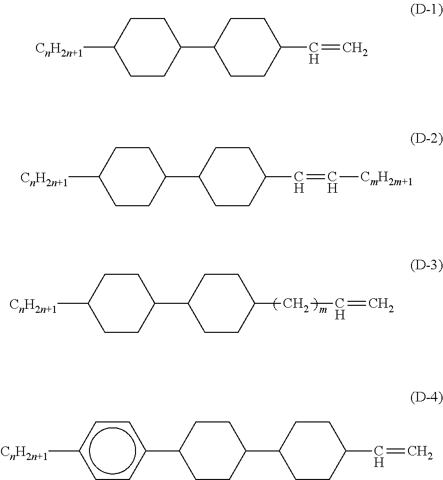

wherein m and n are the same as or different from each other, and each an integer of 1 to 6.

(11) Another aspect of the present invention is directed to a method for manufacturing a liquid crystal display device, including: preparing a pair of substrates; forming an alignment film by applying to a surface of at least one of the substrates an alignment agent that contains a first polymer, having in its main chain at least one selected from a polyamic acid structure and a polyimide structure or a polysiloxane structure, and at least one monomer including at least one monomer represented by the following formula (1); and polymerizing, after the forming an alignment film, the at least one monomer including at least one monomer represented by the following formula (1) so as to form a second polymer,

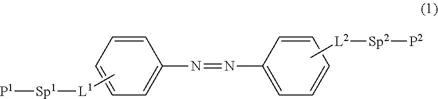

wherein P¹ and P² are the same as or different from each other, and each represent an acryloyloxy, methacryloyloxy, acryloylamino, methacryloylamino, vinyl, or vinyloxy group,

Sp¹ and Sp² are the same as or different from each other, and each represent a C1-C10 linear, branched, or cyclic alkylene or alkenylene group, or a direct bond,

L¹ and L² are the same as or different from each other, and each represent a —NH— group, a —N(CH₃)— group, a —O— group, a —S— group, or a direct bond, and at least one hydrogen atom in each phenylene group is optionally replaced.

(12) In an embodiment of the present invention, the method includes the process (11), and the at least one monomer represented by the formula (1) includes at least one monomer represented by any of the following formulas (2-1) to (2-17).

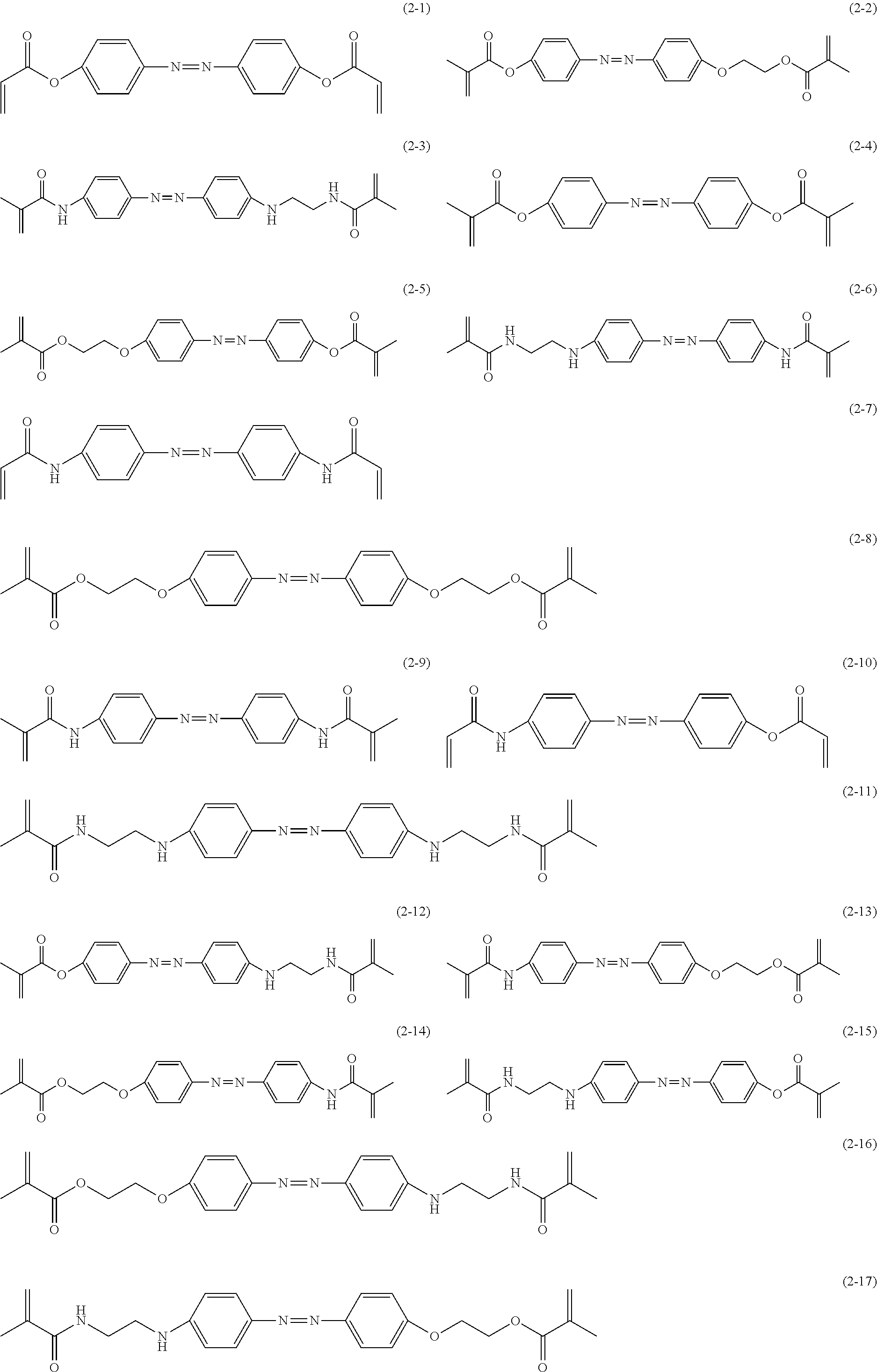

(13) In an embodiment of the present invention, the method includes the process (11) or (12), and the polymerizing includes irradiating the alignment film with ultraviolet rays so as to polymerize the at least one monomer including at least one monomer represented by the formula (1).

(14) In an embodiment of the present invention, the method includes the process (13), and the polymerizing includes irradiating the alignment film with ultraviolet rays so as to polymerize the at least one monomer including at least one monomer represented by the formula (1) and align the first polymer.

(15) In an embodiment of the present invention, the method includes the process (13), and the method further includes forming a liquid crystal layer containing a liquid crystal material between the substrates on at least one of which the alignment film is formed, and transforming the liquid crystal material into an isotropic phase by heating the liquid crystal layer between the substrates, wherein the transforming is followed by the polymerizing, which includes irradiating the alignment film with ultraviolet rays so as to polymerize the at least one monomer including at least one monomer represented by the formula (1).

WO 2010/026721 discloses formation of a polymer by introducing a bifunctional methacrylate monomer into an alignment film. WO 2010/026721, however, does not disclose the second polymer obtained by polymerizing at least one monomer including at least one monomer represented by the formula (1).

The present invention achieves a liquid crystal display device that can reduce crystallization of a liquid crystal material at low temperatures and maintain a favorable voltage holding ratio for a long period of time in exposure to backlight illumination, and a method for manufacturing a liquid crystal display device, which enables manufacture of the above liquid crystal display device.

### BRIEF DESCRIPTION OF THE DRAWINGS

The attached FIGURE is a schematic cross-sectional view of a liquid crystal display device of Embodiment 1.

### DETAILED DESCRIPTION OF THE INVENTION

The present invention is described in more detail below based on the following embodiment with reference to the drawing. The embodiment, however, is not intended to limit the scope of the present invention. The configurations of the embodiment may appropriately be combined or modified within the spirit of the present invention.

The “viewing surface side” as used herein means the side closer to the screen (display surface) of the display device. The “back surface side” means the side farther from the screen (display surface) of the display device. The “room temperature” is 15° C. or higher and 40° C. or lower, unless otherwise specified.

The “photo-functional group” as used herein means a functional group that can undergo a photoreaction. The photo-functional group preferably can undergo a structural change such as dimerization (formation of dimers), isomerization, photo-Fries rearrangement, and decomposition (cleavage) when irradiated with light (electromagnetic waves) such as ultraviolet rays or visible light (preferably polarized light, more preferably polarized ultraviolet rays, particularly preferably linearly polarized ultraviolet rays), and thereby exhibit an ability of controlling the alignment of liquid crystal compounds. Specific examples of the photo-functional group include an azobenzene group, a chalcone group, a cinnamate group, a coumarin group, a tolane group, a stilbene group, and a cyclobutane ring.

The nematic-isotropic phase transition temperature (Tni) as used herein is determined by visually observing the liquid crystal state or the isotropic state while varying the temperature using a device such as one from Mettler. The nematic phase temperature range is determined in a similar manner by visually observing the liquid crystal state or the isotropic state while varying the temperature using a device such as one from Mettler. These temperatures can also be determined by a technique of determining the temperature at which phase transition occurs using a differential scanning calorimeter (DSC).

The mode herein in which liquid crystal molecules are aligned in a direction substantially parallel to a main surface of each of the pair of substrates with no voltage applied is also referred to as a horizontal alignment mode. The expression “substantially parallel” means that, for example, the pre-tilt angle of liquid crystal molecules is 0° or greater and 5° or smaller from the main surface of each substrate. The mode in which liquid crystal molecules are aligned in a direction substantially perpendicular to the main surface of each of the pair of substrates with no voltage applied is also referred to as a vertical alignment mode. The expression “substantially perpendicular” means that, for example, the pre-tilt angle of liquid crystal molecules is 85° or greater and 90° or smaller from the main surface of the substrate. The pre-tilt angle is an angle of the major axis of a liquid crystal material (liquid crystal compound) from a surface of a substrate when the voltage applied to the liquid crystal layer is lower than the threshold voltage (including the case of no voltage application), with the substrate surface taken as 0° and the line normal to the substrate as 90°. The present invention is applicable to both horizontal alignment mode liquid crystal display devices and vertical alignment mode liquid crystal display devices.

### Embodiment 1

The present embodiment is summarized first. The present embodiment takes the following measures (1) and (2) to overcome the above issues.

(1) A bifunctional monomer (preferably methacrylate or acrylate monomer) containing a functional group that absorbs ultraviolet light having a wavelength of about 370 nm or longer is introduced into an alignment film.

(2) The intermolecular interaction between a liquid crystal material (or liquid crystal compound) and an alignment film surface at low temperatures (for example, −20° C. or lower) is strengthened, so that a bifunctional monomer (preferably methacrylate or acrylate monomer) containing a functional group that can stabilize the liquid crystal (nematic) phase is introduced into the alignment film.

These measures are described below.

A liquid crystal material crystallizes at low temperatures (for example, −20° C. or lower) since the intermolecular interaction between its liquid crystal compounds is strong. In particular, crystallization is presumed to more easily occur as the p orbital electron interaction becomes stronger between phenyl groups, phenylene groups, or fluorine-substituted phenyl or phenylene groups in the liquid crystal compounds. In order to prevent the liquid crystal material from crystallizing at low temperatures, the p orbital electron interaction between phenyl groups or phenylene groups is preferably weakened. One effective method thereof is to weaken the interaction between liquid crystal molecules at the alignment film-liquid crystal layer interface using a functional group on an alignment film surface. The functional group also preferably can absorb ultraviolet light having a wavelength of about 370 nm or longer, for enhancement of the resistance against ultraviolet rays. From these viewpoints, the present inventors found that an azobenzene group (functional group derived from azobenzene) is suitable as such a functional group. Azobenzene is a chemical structure represented by the following formula (A). An azobenzene group contains an azo group (—N═N—) between hydrophobic phenyl (phenylene) groups. The azo group contains an unpaired electron but no p orbital electron. Also, being hydrophobic, the azobenzene group itself interacts with a hydrophobic liquid crystal molecule, but does not cause stacking due to p orbital electron interaction, thereby reducing crystallization of a liquid crystal compound. This means that a functional group containing an azobenzene group on an alignment film surface can reduce crystallization of a liquid crystal compound and enhance the light resistance at the same time. Moreover, in order to prevent a decrease in reliability which can be caused by dissolution of the azobenzene group itself into the liquid crystal layer, the compound containing the azobenzene group is made less likely to dissolve in the liquid crystal layer by introducing two or more polymerizable groups (e.g., methacrylate group, acrylate group) into the compound and polymerizing the compound. These techniques can reduce crystallization of the liquid crystal material at low temperatures even when the viscosity of the liquid crystal material is reduced to achieve rapid response of the liquid crystal display device. The techniques also enable the liquid crystal display device to maintain a favorable voltage holding ratio for a long period of time in exposure to backlight illumination.

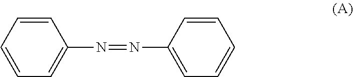 [SMILES: c1ccc(N=Nc2ccccc2)cc1]

WO 2010/026721 fails to disclose or suggest such features of the present embodiment.

The attached FIGURE is a schematic cross-sectional view of a liquid crystal display device of Embodiment 1. As shown in the FIGURE, the liquid crystal display device of Embodiment 1 includes, in the following order from the viewing surface side to the back surface side, a first linear polarizer 10, a counter substrate 20, an alignment film 30, a liquid crystal layer 40, an alignment film 50, a thin-film transistor (TFT) substrate 60, a second linear polarizer 70, and a backlight 80.

The first linear polarizer 10 can be, for example, a polarizer (absorptive polarizer) obtained by dyeing a polyvinyl alcohol (PVA) film with an anisotropic material such as an iodine complex (or dye) to adsorb the anisotropic material on the polyvinyl alcohol film, and stretching the film for alignment. Typically, each surface of a PVA film is laminated with a protective film such as a triacetyl cellulose (TAC) film in practical use for sufficient mechanical strength and sufficient moisture and heat resistance.

The counter substrate 20 is a color filter (CF) substrate that includes, in the following order from the viewing surface side to the back surface side, a transparent substrate (not illustrated), color filters/black matrix (not illustrated), and a flattening film as necessary.

The transparent substrate may be, for example, a glass substrates or a plastic substrate.

The color filters/black matrix have a structure in which red color filters, green color filters, and blue color filters are arranged in a plane and partitioned by a black matrix. The red color filters, the green color filters, the blue color filters, and the black matrix are each made of, for example, a transparent resin containing a pigment. Typically, a combination of a red color filter, a green color filter, and a blue color filter is arranged in each pixel, and the desired color is achieved in each pixel by mixing colors of the red color filter, the green color filter, and the blue color filter while controlling the amount of light passing through the filters.

The alignment films 30 and 50 may be horizontal alignment films configured to align liquid crystal molecules in the direction parallel to their surfaces or may be vertical alignment films configured to align liquid crystal molecules in the direction perpendicular to their surfaces. The alignment films 30 and 50 may be photo-alignment films containing a photo-functional group and having been subjected to photo-alignment as the alignment treatment, rubbed alignment films having been subjected to rubbing as the alignment treatment, or alignment films not having been subjected to any alignment treatment.

Each of the alignment films 30 and 50 contains a first polymer containing in its main chain at least one selected from a polyamic acid structure and a polyimide structure or a polysiloxane structure. Hereinafter, a first polymer containing in its main chain at least one selected from a polyamic acid structure and a polyimide structure is also referred to as a polyimide-based first polymer, and a first polymer containing in its main chain a polysiloxane structure is also referred to as a polysiloxane-based first polymer.

The first polymer preferably has at least one photo-functional group selected from the group consisting of a cinnamate group, an azobenzene structure, a chalcone group, and a coumarin structure, each of which may contain a substituent.

Preferred examples of the substituent include, but are not limited to, a halogen group, a methyl group, a methoxy group, an ethyl group, and an ethoxy group. These may be used alone or in combination with each other. In other words, the substituent preferably includes at least one substituent selected from the group consisting of a halogen group, a methyl group, a methoxy group, an ethyl group, and an ethoxy group. The halogen group is preferably a fluoro group or a chloro group. In the case where the photo-functional group contains a substituent, the substituent usually replaces at least one hydrogen atom in a ring structure, such as a phenylene group, of the photo-functional group. The photo-functional group may be a monovalent functional group, but is preferably a divalent cinnamate group represented by the following formula (B-1), a divalent azobenzene group represented by the following formula (B-2), a divalent chalcone group represented by the following formula (B-3), or a divalent coumarin group represented by the following formula (B-4).

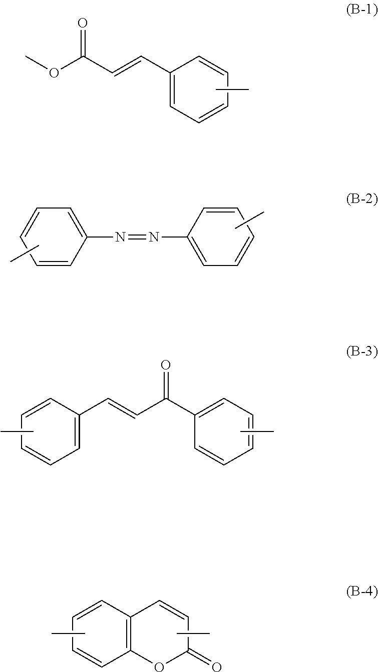

The polyimide-based first polymer has a diamine-derived structure and a tetracarboxylic dianhydride-derived structure as repeating structures, and is obtained by polymerizing at least one diamine and at least one tetracarboxylic dianhydride.

Preferred examples of the polyimide-based first polymer include polyamic acid structures represented by the following formula (C-1) and/or polyimide structures represented by the following formula (C-2).

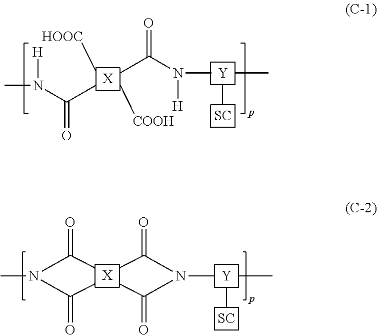

In the formulas, X represents a tetravalent organic group, Y represents a trivalent organic group, SC represents a side chain, and p represents a degree of polymerization, which is an integer of 1 or greater, preferably 10 or greater.

In the formulas (C-1) and (C-2), in the case where X contains a photo-functional group, X may be, for example, a group represented by any of the following formulas (X-1) to (X-4). These groups can be used both in the case where the alignment films 30 and 50 are horizontal alignment films and in the case where the alignment films 30 and 50 are vertical alignment films. These groups may be used alone or in combination with each other.

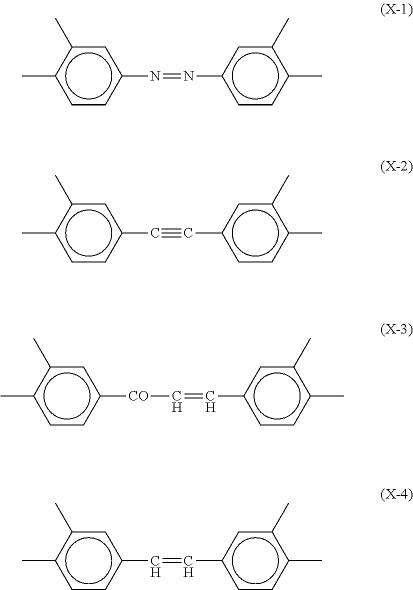

In the formulas (C-1) and (C-2), in the case where X contains no photo-functional group, X may be, for example, a group represented by any of the following formulas (X-5) to (X-16). These groups can be used both in the case where the alignment films 30 and 50 are horizontal alignment films and in the case where the alignment films 30 and 50 are vertical alignment films. These groups may be used alone or in combination with each other.

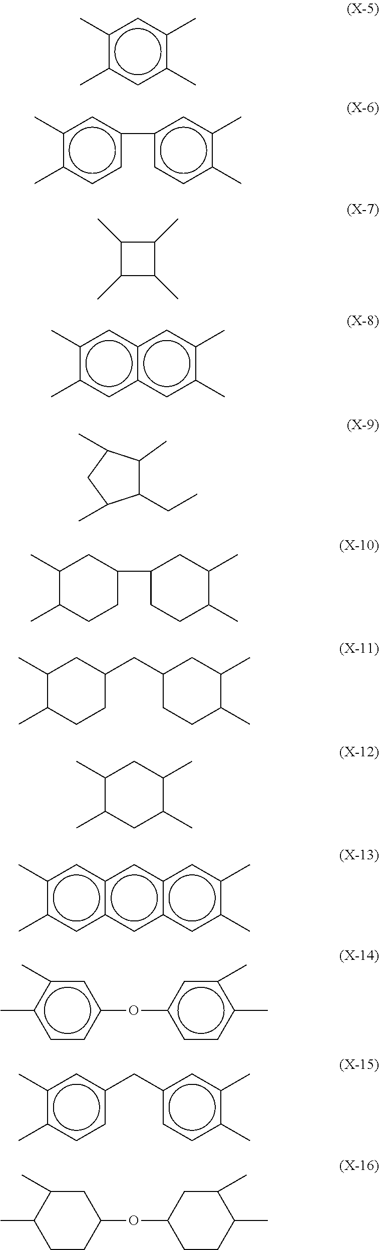

In the formulas (C-1) and (C-2), in the case where Y contains a photo-functional group, Y may be, for example, a group represented by any of the following formulas (Y-1) to (Y-8). These groups can be used both in the case where the alignment films 30 and 50 are horizontal alignment films and in the case where the alignment films 30 and 50 are vertical alignment films. These groups may be used alone or in combination with each other.

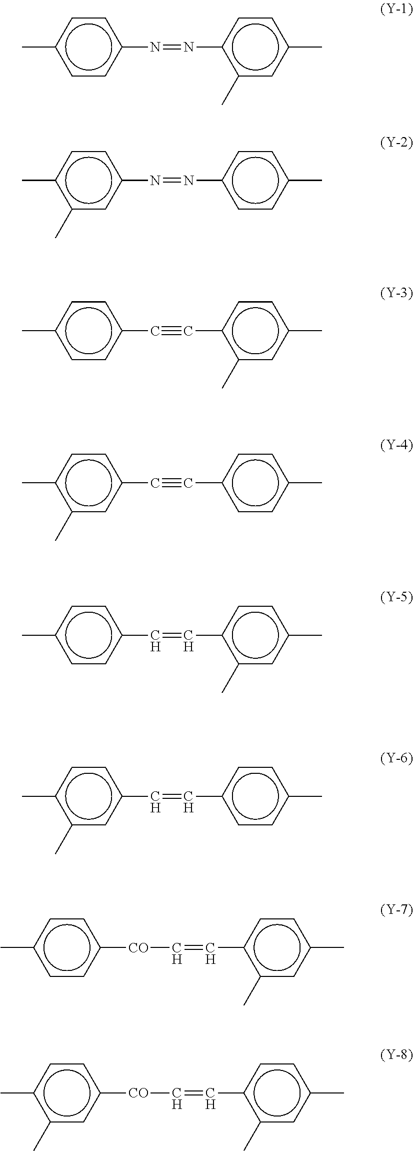

In the formulas (C-1) and (C-2), in the case where Y contains no photo-functional group, Y may be, for example, a group represented by any of the following formulas (Y-9) to (Y-24). These groups can be used both in the case where the alignment films 30 and 50 are horizontal alignment films and in the case where the alignment films 30 and 50 are vertical alignment films. These groups may be used alone or in combination with each other.

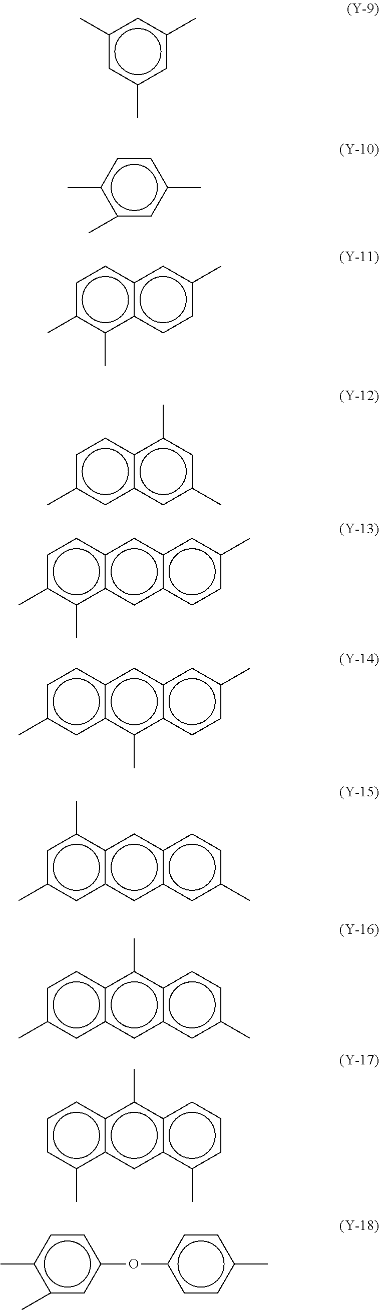

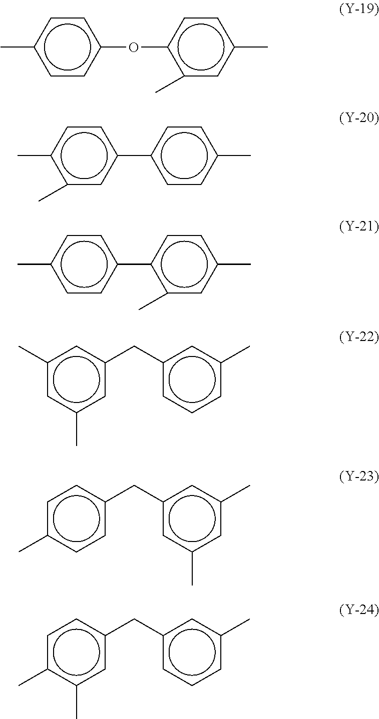

In the case where the alignment films 30 and 50 are photo-alignment films, the SC (side chain) in the formulas (C-1) and (C-2) preferably contains a photo-functional group. Preferred examples of the photo-functional group include monovalent groups represented by any of the following formulas (SC-1) to (SC-6). The groups represented by any of the formulas (SC-1) to (SC-3) can be used in the case where the alignment films 30 and 50 are horizontal alignment films. These groups may be used alone or in combination with each other. The groups represented by any of the formulas (SC-4) to (SC-6) can be used in the case where the alignment films 30 and 50 are vertical alignment films. These groups may be used alone or in combination with each other.

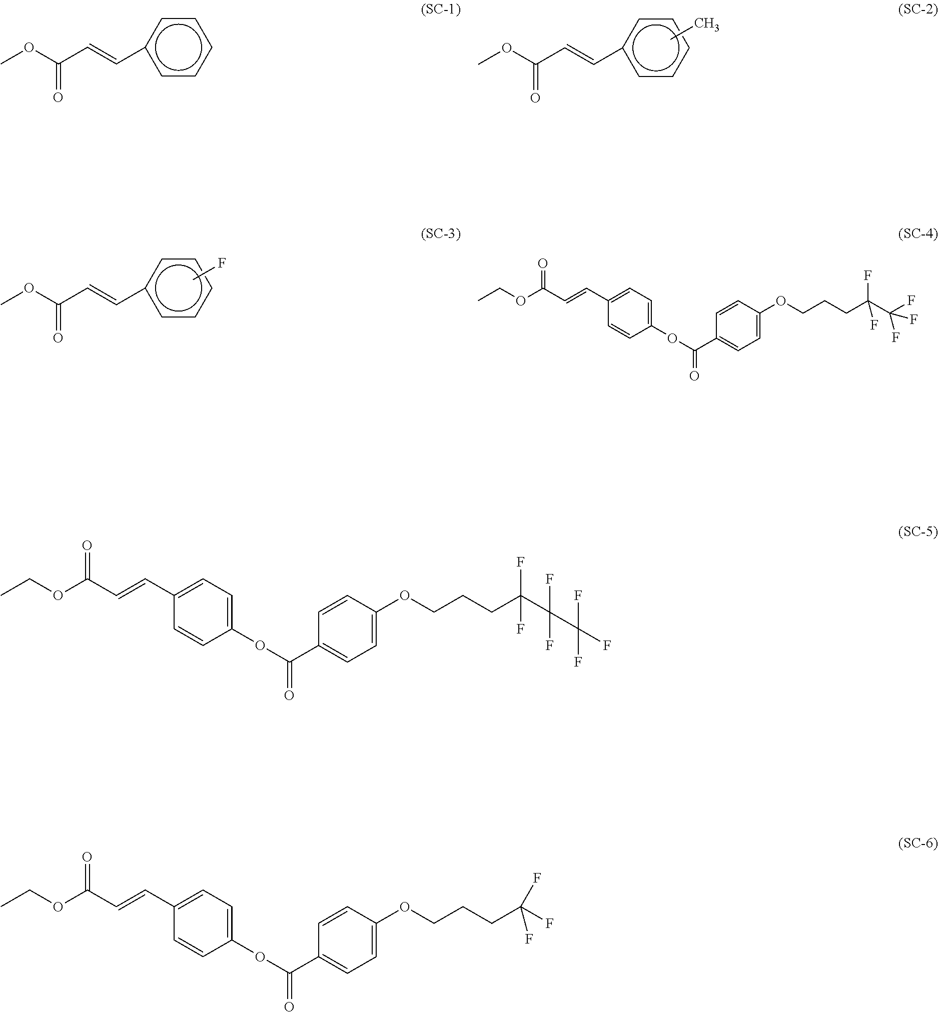

In the case where the alignment films 30 and 50 are not photo-alignment films, the SC (side chain) in the formulas (C-1) and (C-2) may contain a horizontal alignment functional group other than a photo-functional group, such as a monovalent group represented by any of the following formulas (SC-7) to (SC-13). Also, the SC (side chain) may be excluded and a hydrogen atom (hydrogen group) may be bonded to Y. These groups can be used in the case where the alignment films 30 and 50 are horizontal alignment films. These groups may be used alone or in combination with each other.

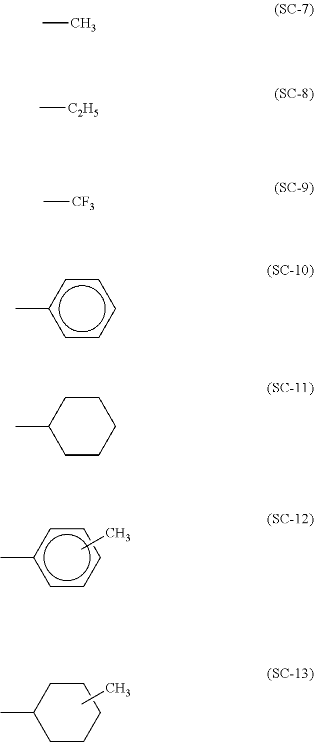

In the case where the alignment films 30 and 50 are not photo-alignment films, the SC (side chain) in the formulas (C-1) and (C-2) may contain a vertical alignment functional group other than a photo-functional group, such as a monovalent group represented by any of the following formulas (SC-14) to (SC-20). These groups can be used in the case where the alignment films 30 and 50 are vertical alignment films. These groups may be used alone or in combination with each other.

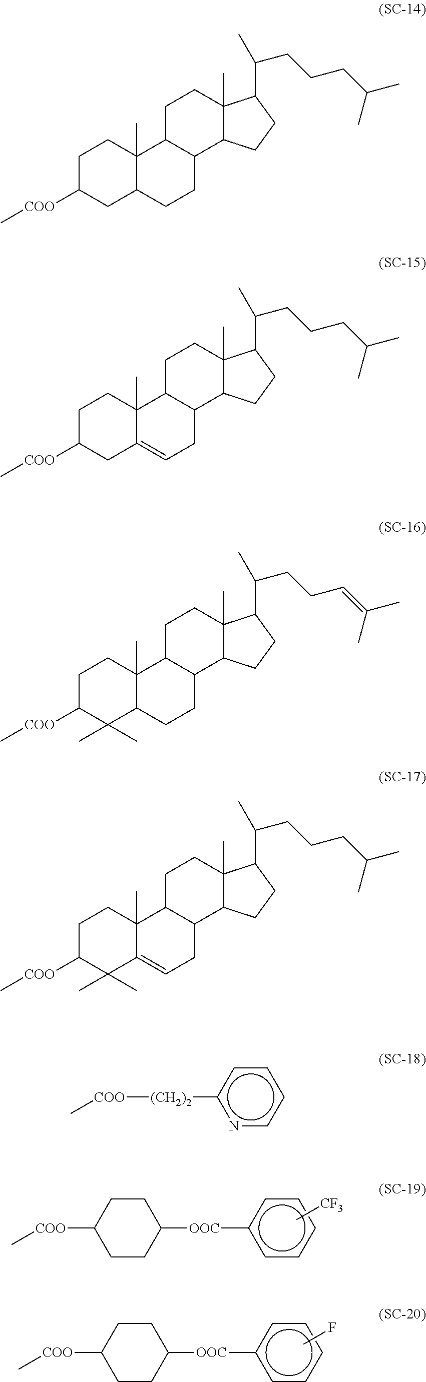

For a high contrast ratio, the alignment films 30 and 50 are preferably photo-alignment films. In the case where the alignment films 30 and 50 each contain a structure represented by the formula (C-1) and/or the formula (C-2), the alignment films 30 and 50 are made into photo-alignment films by introducing a photo-functional group into at least one selected from X, Y, and SC (side chain).

Preferred examples of the polysiloxane-based first polymer include those having a polysiloxane structure represented by the following formula (C-3).

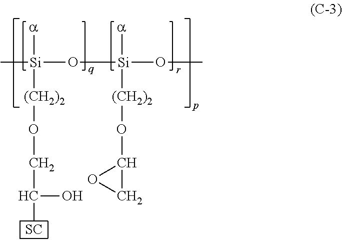

In the formula, as are the same as or different from each other, and each represent a hydrogen atom, a hydroxy group, a methoxy group, or an ethoxy group, SC represents a side chain, p represents a degree of polymerization, p, q, and r are each independently an integer of 1 or greater, p is preferably 10 or greater, and q and r satisfy the relation 0≤r/(q+r)≤1, preferably the relation 0≤r/(q+r)≤0.5.

In the case where the alignment films 30 and 50 are photo-alignment films, the SC (side chain) in the formula (C-3) preferably contains a photo-functional group. Preferred examples of the photo-functional group include monovalent groups represented by any of the following formulas (SC-21) to (SC-25). Groups represented by any of the formulas (SC-21) and (SC-22) can be used in the case where the alignment films 30 and 50 are vertical alignment films. These groups may be used alone or in combination with each other. Groups represented by any of the formulas (SC-23) to (SC-25) can be used in the case where the alignment films 30 and 50 are horizontal alignment films. These groups may be used alone or in combination with each other.

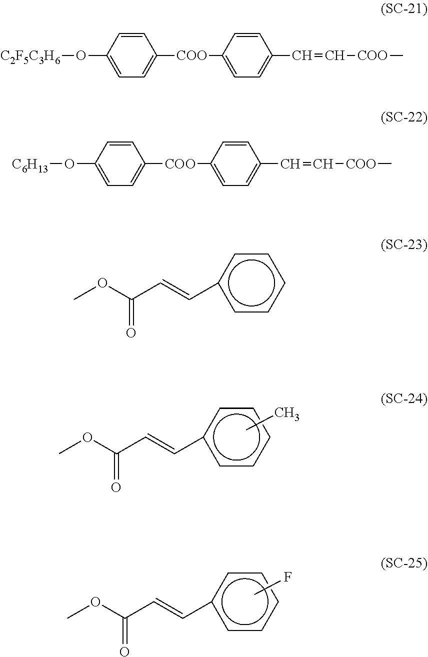

Each of the alignment films 30 and 50 further contains a second polymer obtained by polymerizing at least one monomer including at least one monomer represented by the following formula (1) (hereinafter, also referred to as the monomer (1)). A liquid crystal display device with such alignment films can reduce crystallization of a liquid crystal material at low temperatures (for example, −20° C. or lower) as described above. The liquid crystal, display device can also maintain a favorable voltage holding ratio for a long period of time in exposure to backlight illumination. The second polymer may have a unit derived from the monomer (1) as a main unit or may have a unit derived from the monomer (1) alone.

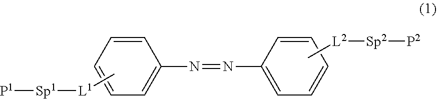

In the formula, P¹ and P² are the same as or different from each other, and each represent an acryloyloxy, methacryloyloxy, acryloylamino, methacryloylamino, vinyl, or vinyloxy group, Sp¹ and Sp² are the same as or different from each other, and each represent a C1-C10 linear, branched, or cyclic alkylene or alkenylene group, or a direct bond, L¹ and L² are the same as or different from each other, and each represent a —NH— group, a —N(CH₃)— group, a —O— group, a —S— group, or a direct bond, and at least one hydrogen atom in each phenylene group is optionally replaced.

In the formula (1), at least one hydrogen atom of each phenylene group is optionally replaced by a halogen atom (preferably a fluorine or chlorine atom), or a methyl, methoxy, ethyl, or ethoxy group.

Specific preferred examples of the monomer (1) include monomers represented by any of the following formulas (2-1) to (2-17). These may be used alone or in combination with each other.

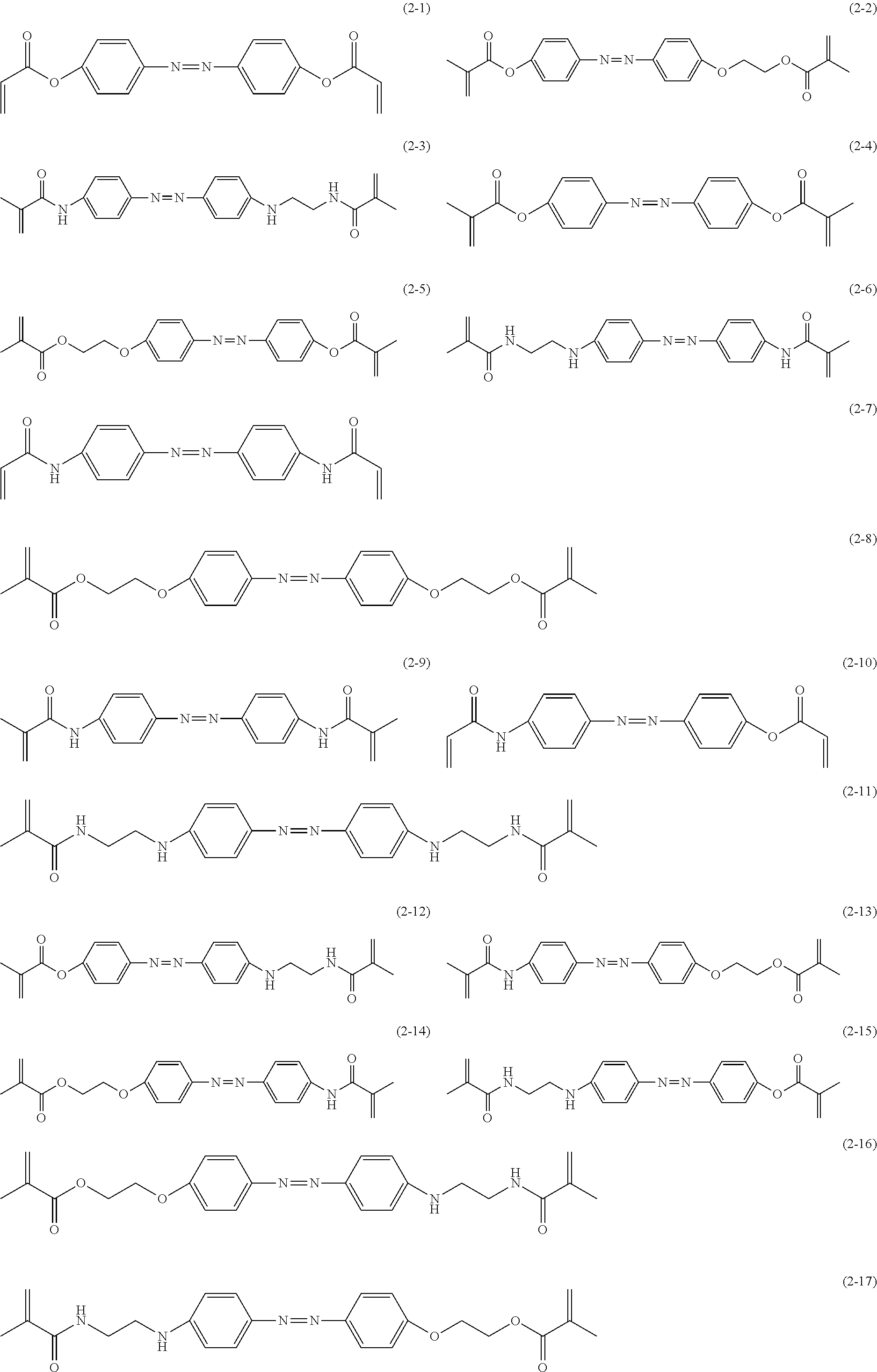

The alignment film 30 includes a lower layer 31 and an upper layer 32 disposed on the liquid crystal layer 40 side of the lower layer 31. The alignment film 50 includes a lower layer 51 and an upper layer 52 disposed on the liquid crystal layer 40 side of the lower layer 51. The lower layers 31 and 51 are formed from the first polymer. The upper layers 32 and 52 are formed from the second polymer. Between the lower layer 31 and the upper layer 32 and between the lower layer 51 and the upper layer 52 may be disposed an interlayer (not illustrated) containing both the first polymer and the second polymer.

The lower layers 31 and 51 may be photo-alignment layers that can function as photo-alignment films. The alignment films 30 and 50 can therefore be photo-alignment films.

The lower layers 31 and 51 may be vertical alignment layers that can function as vertical alignment films. The alignment films 30 and 50 can therefore be vertical alignment films.

The lower layers 31 and 51 may be horizontal alignment layers that can function as horizontal alignment films. The alignment films 30 and 50 can therefore be horizontal alignment films.

The liquid crystal layer 40 contains a liquid crystal material (nematic liquid crystal) containing at least one liquid crystal compound (liquid crystal molecules) and exhibiting a nematic phase. The liquid crystal material transforms from the nematic phase into an isotropic phase when the temperature being increased from the nematic temperature reaches a certain critical temperature (nematic-isotropic phase transition temperature (Tni)).

The liquid crystal material has a Tni of 75° C. or lower and a nematic phase temperature range narrower than 100° C. Such a liquid crystal material can have a low viscosity to enhance the response performance of the liquid crystal display device, making the liquid crystal display device suitable for HMD applications. Although the liquid crystal material is likely to crystallize at low temperatures, the present embodiment, employing the alignment films 30 and 50 each containing the second polymer obtained by polymerizing the monomer (1) as described above, can effectively reduce crystallization of the liquid crystal material at low temperatures (for example, −20° C. or lower). The upper limit of the Tni is preferably 72° C. or lower. The lower limit of the Tni is preferably 60° C. or higher, more preferably 65° C. or higher. The nematic phase temperature range is preferably from 80° C. to lower than 100° C., more preferably from 85° C. to 90° C.

The anisotropy of dielectric constant (Δε) represented by the following formula of the liquid crystal material and the liquid crystal compound may be positive or negative. The liquid crystal material may also contain a liquid crystal compound having no polarity, i.e., having an anisotropy Δε of substantially 0 (neutral liquid crystal compound). Examples of the neutral liquid crystal compound include liquid crystal compounds having an alkene structure. Hereinafter, a liquid crystal material having positive anisotropy of dielectric constant and a liquid crystal material having negative anisotropy of dielectric constant are also referred to as a positive liquid crystal material and a negative liquid crystal material, respectively.

Δε=(dielectric constant in major axis direction)−(dielectric constant in minor axis direction)

In order to reduce the viscosity of the liquid crystal material to enhance the response performance of the liquid crystal display device, the liquid crystal material preferably contains a liquid crystal compound containing an alkenyl group in an amount of 7 wt % or more and 40 wt % or less, more preferably 10 wt % or more and 35 wt % or less (relative to the whole liquid crystal material constituting the liquid crystal layer 40).

The liquid crystal compound containing an alkenyl group may be a compound represented by any of the following formulas (D-1) to (D-4). These may be used alone or two or more thereof may be used in combination with each other.

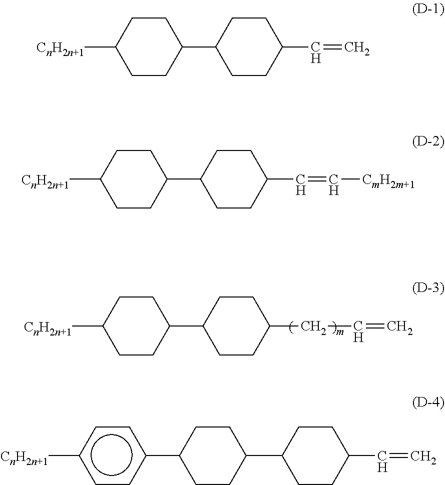

In the formulas, m and n are the same as or different from each other, and each an integer of 1 to 6.

Specific preferred examples of the liquid crystal compound containing an alkenyl group include compounds represented by the following formula (D-1-1). These compounds are especially effective in reducing the viscosity to achieve rapid response, but are likely to cause crystallization of the liquid crystal material at low temperatures due to their low molecular weight. The present embodiment, employing the alignment films 30 and 50 each containing the second polymer obtained by polymerizing the monomer (1) as described above, can effectively reduce crystallization of the liquid crystal material at low temperatures (for example, −20° C. or lower) even with these compounds.

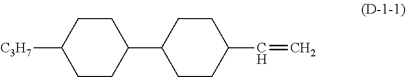

The thin-film transistor (TFT) substrate 60 can be an active matrix substrate usually used in the field of liquid crystal display panels. The liquid crystal driving mode for the liquid crystal display device of the present embodiment may be any mode such as the twisted nematic (TN) mode, the electrically controlled birefringence (ECB) mode, a horizontal alignment mode including the FFS mode and the IPS mode, or a vertical alignment mode including the 4-domain reverse twisted nematic (4D-RTN) mode and the multi-domain vertical alignment (MVA) mode.

In the case where the liquid crystal driving mode of the liquid crystal display device of the present embodiment is the FFS mode, the TFT substrate 60 includes, for example, a supporting substrate, a common electrode (planar electrode) disposed on the liquid crystal layer 40 side of the supporting substrate, an insulating film covering the common electrode, and pixel electrodes (comb electrodes) disposed on the liquid crystal layer 40 side of the insulating film. This structure can generate horizontal electric fields (fringe electric fields) in the liquid crystal layer 40 by applying voltage between the common electrode and the pixel electrodes constituting a pair of electrodes. Thus, controlling the voltage applied between the common electrode and the pixel electrodes enables control of the alignment of the liquid crystals in the liquid crystal layer 40.

In the case where the liquid crystal driving mode for the liquid crystal display device of the present embodiment is the IPS mode, the liquid crystal display device applies voltage to the pair of comb electrodes disposed in the TFT substrate 60 to generate horizontal electric fields in the liquid crystal layer 40, thereby controlling the alignment of the liquid crystals in the liquid crystal layer 40.

In the case where the liquid crystal driving mode for the liquid crystal display device of the present embodiment is the vertical alignment mode, the TFT substrate 60 includes pixel electrodes, and the counter substrate 20 includes a common electrode. The liquid crystal display device applies voltage between the common electrode and the pixel electrodes to generate vertical electric fields in the liquid crystal layer 40, thereby controlling the alignment of the liquid crystals in the liquid crystal layer 40. In the 4D-RTN mode, the alignment films 30 and 50 are subjected to alignment treatment in opposite (antiparallel) directions in each pixel, and the TFT substrate 60 and the counter substrate 20 are bonded to each other such that the alignment treatment directions for the alignment films 30 and 50 are perpendicular to each other. This can define four alignment directions (domains), which are different from each other, in each pixel.

The second linear polarizer 70 can be the same polarizer as that used for the first linear polarizer 10. The transmission axis of the first linear polarizer 10 and the transmission axis of the second linear polarizer 70 are preferably perpendicular to each other. This configuration sets the first linear polarizer 10 and the second linear polarizer 70 in crossed Nicols, achieving a favorable black display state with no voltage applied.

The backlight 80 may be of any type and may be, for example, an edge-lit backlight or a direct-lit backlight. The backlight 80 may utilize any light source such as a light emitting diode (LED) or a cold cathode fluorescent lamp (CCFL). The amount of light emitted from the backlight 80 and transmitted by the light crystal panel is controlled by the voltage applied to the liquid crystal layer 40.

The liquid crystal display device of Embodiment 1 may include any other members. For example, with an anti-reflection film disposed on the viewing surface side of the first linear polarizer 10, the reflectance of the liquid crystal panel can be further decreased. The anti-reflection film is preferably a moth-eye film having a surface structure like a moth's eye.

The method for manufacturing the liquid crystal display device of the present embodiment is described.

First, the counter substrate 20 and the TFT substrate 60 are produced by common methods to prepare the counter substrate 20 and the TFT substrate 60 as a pair of substrates (preparation process).

To the surface of each of the substrates 20 and 60 is applied an alignment agent containing the first polymer containing in its main chain at least one selected from a polyamic acid structure and a polyimide structure or a polysiloxane structure (i.e., polyimide-based first polymer or polysiloxane-based first polymer) and at least one monomer including at least one monomer (monomer (1)) represented by the formula (1) (hereinafter, also referred to as an additional monomer) so that alignment films are formed (film forming process). Specifically, the polyimide-based first polymer or polysiloxane-based first polymer and the additional monomer including the monomer (1) are dissolved in a solvent (for example, organic solvent) to prepare an alignment agent. The amount of the additional monomer introduced is preferably 1 to 30 wt %, more preferably 5 to 25 wt %, of the amount of the first polymer. The additional monomer may include the monomer (1) as a main monomer or may be composed of the monomer (1) alone. To the surface of each of the substrates 20 and 60 is applied the alignment agent by a method such as roll coating, spin coating, printing, or ink jetting. The surface of each of the substrates 20 and 60 is heated to volatilize the solvent in the alignment agent, whereby the alignment films 30 and 50 are formed. The heating may include two processes of pre-baking and post-baking. The post-baking may include two processes, so that a total of three heating processes may be performed. In the case of using the polyimide-based first polymer, the post-baking may involve partial imidization of a polyamic acid structure into a polyimide structure. The post-baking is also considered to cause separation of the first polymer and the additional monomer including the monomer (1).

The film forming is followed by forming a second polymer by polymerizing the additional monomer including the monomer (1) (polymerization process). Preferably, the alignment films 30 and 50 are irradiated with ultraviolet rays such that the additional monomer including the monomer (1) is polymerized. This forms the alignment film 30 including the lower layer 31 and the upper layer 32 and the alignment film 50 including the lower layer 51 and the upper layer 52. In the case where the alignment films 30 and 50 are photo-alignment films, the ultraviolet irradiation may cause polymerization of the additional monomer including the monomer (1) and, simultaneously, photo-alignment treatment on the alignment films 30 and 50, especially the first polymer. In the case where the ultraviolet irradiation causes the photo-alignment treatment as well, the ultraviolet rays applied are preferably linearly polarized ultraviolet rays.

Between the substrates 20 and 60 having formed thereon the alignment films 30 and 50, respectively, is formed the liquid crystal layer 40 containing a liquid crystal material (liquid crystal layer formation). The liquid crystal material preferably has a nematic-isotropic phase transition temperature Tni of 75° C. or lower and a nematic phase temperature range narrower than 100° C. The liquid crystal layer formation is achieved by vacuum filling or one drop filling. The vacuum filling includes processes in the following order: application of a sealant; bonding of the substrates 20 and 60; curing of the sealant; injection of the liquid crystal material; and sealing of the injection ports. The one drop filling includes processes in the following order: application of a sealant; dropping of the liquid crystal material; bonding of the substrates 20 and 60; and curing of the sealant. These result in a liquid crystal cell filled with the liquid crystal material.

The liquid crystal layer 40 between the substrates 20 and 60 is then heated to transform the liquid crystal material into an isotropic phase (isotropic phase treatment). The heating temperature here may be any temperature higher than the nematic-isotropic phase transition temperature Tni of the liquid crystal material and is, for example, 100° C. to 150° C. The heating duration is, for example, 30 to 60 minutes. The isotropic phase treatment is followed by cooling the liquid crystal cell to room temperature.

The polymerization may be performed after the isotropic phase treatment, i.e., the alignment films may be irradiated with ultraviolet rays to polymerize the monomer (1) after the isotropic phase treatment. This method is suitable in the case where the alignment films 30 and 50 are not photo-alignment films.

In any case, the irradiation conditions such as the energy and wavelengths of ultraviolet rays applied to polymerize the additional monomer including the monomer (1) are not limited, and can appropriately be determined based on whether or not the alignment films 30 and 50 are photo-alignment films or based on the material of the alignment films 30 and 50.

The above processes are followed by bonding of polarizers and mounting of members such as a controller, a power source, and a backlight. Thereby, the liquid crystal display device of the present embodiment is completed.

An embodiment of the present invention was described above. Each and every feature of the embodiment is applicable to all the aspects of the present invention.

The present invention is described in more detail below based on examples and comparative examples. The examples, however, are not intended to limit the scope of the present invention.

### Example 1-1

### (Preparation of Alignment Agent)

To a photo-alignment agent containing a polyamic acid that is represented by the following formula (E) and contains a photo-functional group in a side chain was introduced a monomer containing an azobenzene group represented by the following formula (2-4). The solvent used was a mixed solvent of N-methylpyrrolidone (NMP) and γ-butyrolactone. The amount of the monomer introduced was 1 wt % of the amount of the solute (polyamic acid).

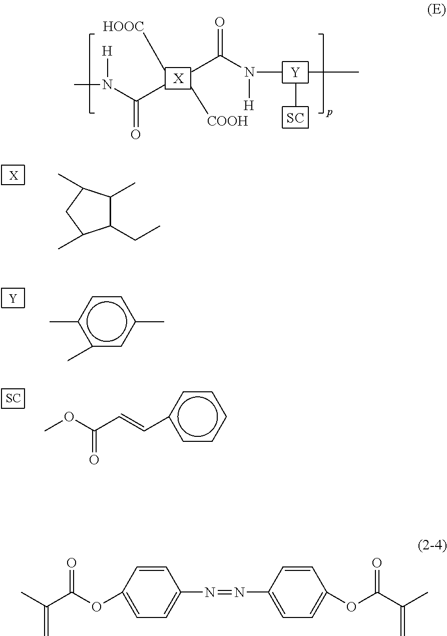

### (Production of Liquid Crystal Cell)

A TFT substrate and a counter substrate with no electrode were prepared. The photo-alignment agent was applied to each substrate, and pre-baked at 80° C. for two minutes, followed by post-baking at 200° C. for 40 minutes. The photo-alignment agent was irradiated with linearly polarized light (including ultraviolet light having a wavelength of 310 to 370 nm) with an intensity of 500 mJ/cm², so that the photo-alignment treatment and polymerization of the monomer were performed simultaneously. To one of the substrates was applied an ultraviolet-curable, thermosetting sealant (Sekisui Chemical Co., Ltd.) in a predetermined pattern using a dispenser. Onto the predetermined positions of the other substrate was dropped a positive liquid crystal material A (Δn=0.15, Δε=2.5) having a Tni of 70° C. and a liquid crystal (nematic) phase temperature range narrower than 100° C. (specifically, 90° C. to 95° C.). The liquid crystal material contains 10 wt % or more of a liquid crystal compound represented by the following formula (D-1-1). The substrates were then bonded to each other in vacuum, and the sealant was cured by ultraviolet light (including ultraviolet light having a wavelength of 300 to 400 nm). The substrates were further heated at 130° C. for 40 minutes to thermally cure the sealant and perform realignment treatment such that the liquid crystal transformed into an isotropic phase. The substrates were cooled down to room temperature, and thereby an FFS-mode liquid crystal cell was obtained.

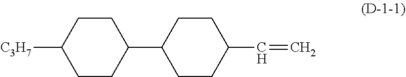

### Example 1-2

An FFS mode liquid crystal cell was produced as in Example 1-1, except that the amount of the monomer introduced was changed to 5 wt % of the amount of the solute (polyamic acid).

### Example 1-3

An FFS mode liquid crystal cell was produced as in Example 1-1, except that the amount of the monomer introduced was changed to 10 wt % of the amount of the solute (polyamic acid).

### Example 1-4

An FFS mode liquid crystal cell was produced as in Example 1-1, except that the amount of the monomer introduced was changed to 20 wt % of the amount of the solute (polyamic acid).

### Example 1-5

An FFS mode liquid crystal cell was produced as in Example 1-1, except that the amount of the monomer introduced was changed to 25 wt % of the amount of the solute (polyamic acid).

### Example 1-6

An FFS mode liquid crystal cell was produced as in Example 1-1, except that the amount of the monomer introduced was changed to 30 wt % of the amount of the solute (polyamic acid).

### Example 1-7

An FFS mode liquid crystal cell was produced as in Example 1-1, except that the amount of the monomer introduced was changed to 10 wt % of the amount of the solute (polyamic acid), and the liquid crystal material used was a positive liquid crystal material B (Δn=0.15, Δε=2.5) having a Tni of 80° C. and a liquid crystal (nematic) phase temperature range of 100° C. or wider (specifically, wider than 100° C. and not wider than 105° C.) and containing 3 wt % or less of a liquid crystal compound represented by the formula (D-1-1).

### Comparative Example 1-1

An FFS mode liquid crystal cell was produced as in Example 1-1, except that no monomer was introduced (the amount of the monomer introduced was 0 wt %).

### (Electro-Optical Characteristics and Response Performance at 25° C.)

The response performance (sum of the rise response τr and the decay response τd) of the liquid crystal cell was determined at a cell surface temperature of 25° C. using Photoal from Otsuka Electronics Co., Ltd.

### (Low-Temperature Storage Test)

The liquid crystal cell was placed in a −20° C. thermostat bath and left to stand for 1000 hours to determine whether or not crystallization occurred.

### (Backlight Exposure Test)

In order to evaluate the reliability of the liquid crystal cell, the liquid crystal display device was subjected to a backlight exposure test at 25° C. for 1000 hours. The voltage holding ratio (VHR) was measured before and after the backlight exposure at 1 V and 70° C. using a VHR measurement system Model 6254 (Toyo Corp.).

The results are shown in the following Table 1.

TABLE 1

| | | | Response | −20° C | Backlight | |
|---|---|---|---|---|---|---|
| | Monomer | Liquid | performance | storage | exposure | |
| | introduced | crystal | τr + τd (ms) | Crystal | VHR (%) | |
| | (wt %) | material | (25° C.) | deposition | 0 h | 1000 h |
| Com- | 0 | A | 10.4 | Occured | 99.3 | 95.1 |
| parative | | | | | | |
| Example | | | | | | |
| 1-1 | | | | | | |
| Example | 1 | A | 10.4 | Not | 99.3 | 98.4 |
| 1-1 | | | | occurred | | |
| Example | 5 | A | 10.4 | Not | 99.3 | 98.8 |
| 1-2 | | | | occurred | | |
| Example | 10 | A | 10.4 | Not | 99.3 | 98.8 |
| 1-3 | | | | occurred | | |
| Example | 20 | A | 10.3 | Not | 99.4 | 99.0 |
| 1-4 | | | | occurred | | |
| Example | 25 | A | 10.4 | Not | 99.4 | 99.0 |
| 1-5 | | | | occurred | | |
| Example | 30 | A | 10.4 | Not | 98.4 | 96.3 |
| 1-6 | | | | occurred | | |
| Example | 10 | B | 16.4 | Not | 99.4 | 98.9 |
| 1-7 | | | | occurred | | |

In the case where the alignment films contained no polymer of the monomer (Comparative Example 1-1), crystallization occurred in the −20° C. storage, and the VHR decreased to 95% in the backlight exposure. This is presumably because the liquid crystal material contained 10 wt % or more of the liquid crystal compound represented by the formula (D-1-1), which crystalizes easily, and no polymer of the monomer represented by the formula (2-4), which blocks ultraviolet light.

In contrast, in Examples 1-1 to 1-5, crystallization did not occur in the −20° C. storage and the VHR did not decrease in the backlight aging. This is presumably because the azobenzene group in the formula (2-4) interacted with the liquid crystal molecules to reduce crystal deposition and effectively blocked ultraviolet light from the backlight. In Example 1-6 in which the amount of the monomer introduced was 30 wt %, the high monomer content caused the alignment films to be white opaque and gave a low VHR in an early stage. Here, some monomers might have dissolved in the liquid crystal layer.

In Example 1-7 utilizing the liquid crystal material B, crystallization did not occur in the −20° C. storage and the VHR was high before and after the backlight exposure, but the response performance deteriorated. This is presumably because the liquid crystal material B had a high viscosity.

### Example 2-1

### (Preparation of Alignment Agent)

To a photo-alignment agent containing a polyamic acid that is represented by the following formula (F) and contains a photo-functional group in its main chain was introduced a monomer containing an azobenzene group represented by the following formula (2-1). The solvent used was a mixed solvent of NMP and γ-butyrolactone. The amount of the monomer introduced was 1 wt % of the amount of the solute (polyamic acid).

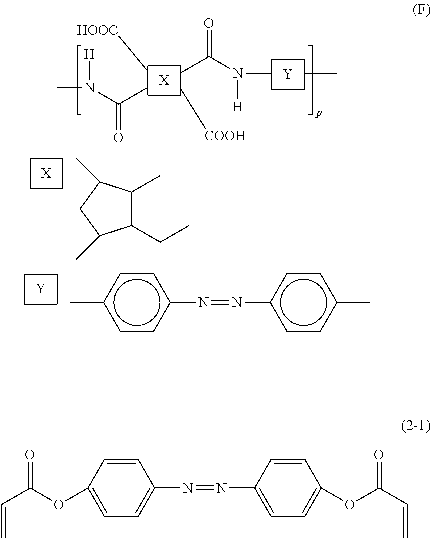

### (Production of Liquid Crystal Cell)

A TFT substrate and a counter substrate with no electrode were prepared. The photo-alignment agent was applied to each substrate, and pre-baked at 80° C. for two minutes, followed by first post-baking at 120° C. for 20 minutes. The photo-alignment agent was irradiated with linearly polarized light (including ultraviolet light having a wavelength of 310 to 370 nm) with an intensity of 2 J/cm², so that the photo-alignment treatment and polymerization of the monomer were performed simultaneously. The photo-alignment agent was then subjected to second post-baking at 230° C. for 40 minutes. To one of the substrates was applied an ultraviolet-curable, thermosetting sealant (Sekisui Chemical Co., Ltd.) in a predetermined pattern using a dispenser. Onto the predetermined positions of the other substrate was dropped a positive liquid crystal material C (Δn=0.14, Δε=2.6) having a Tni of 72° C. and a liquid crystal (nematic) phase temperature range narrower than 100° C. (specifically, 90° C. to 95° C.). The liquid crystal material contains 10 wt % or more of a liquid crystal compound represented by the formula (D-1-1). The substrates were then bonded to each other in vacuum, and the sealant was cured by ultraviolet light (including ultraviolet light having a wavelength of 300 to 400 nm). The substrates were further heated at 130° C. for 40 minutes to thermally cure the sealant and perform realignment treatment such that the liquid crystal transformed into an isotropic phase. The substrates were cooled down to room temperature, and thereby an FFS-mode liquid crystal cell was obtained.

### Example 2-2

An FFS mode liquid crystal cell was produced as in Example 2-1, except that the amount of the monomer introduced was changed to 5 wt % of the amount of the solute (polyamic acid).

### Example 2-3

An FFS mode liquid crystal cell was produced as in Example 2-1, except that the amount of the monomer introduced was changed to 10 wt % of the amount of the solute (polyamic acid).

### Example 2-4

An FFS mode liquid crystal cell was produced as in Example 2-1, except that the amount of the monomer introduced was changed to 20 wt % of the amount of the solute (polyamic acid).

### Example 2-5

An FFS mode liquid crystal cell was produced as in Example 2-1, except that the amount of the monomer introduced was changed to 25 wt % of the amount of the solute (polyamic acid).

### Example 2-6

An FFS mode liquid crystal cell was produced as in Example 2-1, except that the amount of the monomer introduced was changed to 30 wt % of the amount of the solute (polyamic acid).

### Example 2-7

An FFS mode liquid crystal cell was produced as in Example 2-1, except that the amount of the monomer introduced was changed to 10 wt % of the amount of the solute (polyamic acid), and the liquid crystal material used was a positive liquid crystal material D (Δn=0.14, Δε=2.6) having a Tni of 70° C. and a liquid crystal (nematic) phase temperature range narrower than 100° C. (specifically, 90° C. to 95° C.) and containing no liquid crystal compound represented by the formula (D-1-1).

### Comparative Example 2-1

An FFS mode liquid crystal cell was produced as in Example 2-1, except that no monomer was introduced (the amount of the monomer introduced was 0 wt %).

The liquid crystal cells were subjected to the same evaluations as in Example 1-1 and the other examples. The results are shown in the following Table 2.

TABLE 2

| | | | Response | −20° C | Backlight | |
|---|---|---|---|---|---|---|
| | Monomer | Liquid | performance | storage | exposure | |
| | introduced | crystal | τr + τd (ms) | Crystal | VHR (%) | |
| | (wt %) | material | (25° C.) | deposition | 0 h | 1000 h |
| Com- | 0 | C | 11.6 | Occured | 99.2 | 95.5 |
| parative | | | | | | |
| Example | | | | | | |
| 2-1 | | | | | | |
| Example | 1 | C | 11.5 | Not | 99.3 | 99.0 |
| 2-1 | | | | occurred | | |
| Example | 5 | C | 11.6 | Not | 99.3 | 99.0 |
| 2-2 | | | | occurred | | |
| Example | 10 | C | 11.5 | Not | 99.3 | 99.2 |
| 2-3 | | | | occurred | | |
| Example | 20 | C | 11.6 | Not | 99.3 | 99.2 |
| 2-4 | | | | occurred | | |
| Example | 25 | C | 11.5 | Not | 99.3 | 99.1 |
| 2-5 | | | | occurred | | |
| Example | 30 | C | 11.5 | Not | 98.9 | 95.8 |
| 2-6 | | | | occurred | | |
| Example | 10 | D | 19.3 | Not | 99.5 | 99.0 |
| 2-7 | | | | occurred | | |

In the case where the alignment films contained no polymer of the monomer (Comparative Example 2-1), crystallization occurred in the −20° C. storage, and the VHR decreased to 95%-96% (exclusive of 96%) in the backlight exposure. This is presumably because the liquid crystal material contained 10 wt % or more of the liquid crystal compound represented by the formula (D-1-1), which crystalizes easily, and no polymer of the monomer represented by the formula (2-1), which blocks ultraviolet light.

In contrast, in Examples 2-1 to 2-5, crystallization did not occur in the −20° C. storage and the VHR did not decrease in the backlight aging. This is presumably because the azobenzene group in the formula (2-1) interacted with the liquid crystal molecules to reduce crystal deposition and effectively blocked ultraviolet light from the backlight. In Example 2-6 in which the amount of the monomer introduced was 30 wt %, the high monomer content caused the alignment films to be white opaque and gave a low VHR in an early stage. Here, some monomers might have dissolved in the liquid crystal layer.

In Example 2-7 utilizing the liquid crystal material D, crystallization did not occur in the −20° C. storage and the VHR was high before and after the backlight exposure, but the response performance deteriorated. This is presumably because the liquid crystal material D contained no liquid crystal compound represented by the formula (D-1-1) and thus had a high viscosity.

### Example 3-1

### (Preparation of Alignment Agent)

To a photo-alignment agent containing a polysiloxane that is represented by the following formula (G) and contains two photo-functional groups (introduced at 1:1) in a side chain was introduced a monomer containing an azobenzene group represented by the following formula (2-10). The solvent used was a mixed solvent of NMP and γ-butyrolactone. The amount of the monomer introduced was 1 wt % of the amount of the solute (polysiloxane).

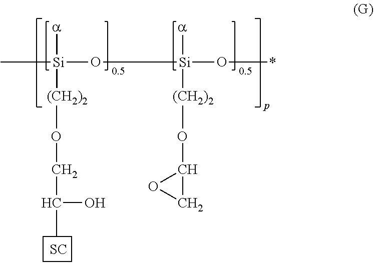

α: Methoxy group
SC (side chain): the following two (introduced at 1:1)

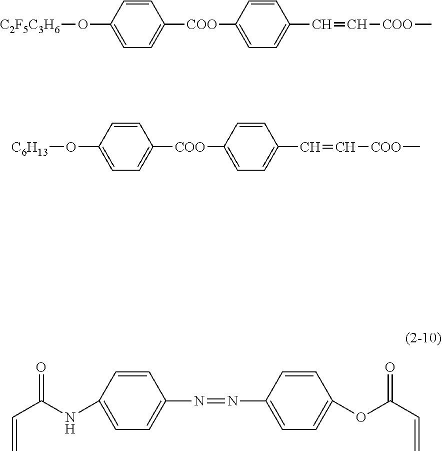

### (Production of Liquid Crystal Cell)

A pair of substrates each having an ITO electrode on its entire surface was prepared. The photo-alignment agent was applied to each substrate, and pre-baked at 80° C. for two minutes, followed by post-baking at 230° C. for 40 minutes. The photo-alignment agent was irradiated with linearly polarized light (including ultraviolet light having a wavelength of 280 to 330 nm) with an intensity of 30 mJ/cm², so that the photo-alignment treatment and polymerization of the monomer were performed simultaneously. To one of the substrates was applied an ultraviolet-curable, thermosetting sealant (Sekisui Chemical Co., Ltd.) in a predetermined pattern using a dispenser. Onto the predetermined positions of the other substrate was dropped a negative liquid crystal material E (Δn=0.12, Δε=−2.8) having a Tni of 70° C. and a liquid crystal (nematic) phase temperature range narrower than 100° C. (specifically, 90° C. to 95° C.). The liquid crystal material contains 7 wt % or more of a liquid crystal compound represented by the formula (D-1-1). The substrates were then bonded to each other in vacuum, and the sealant was cured by ultraviolet light (including ultraviolet light having a wavelength of 300 to 400 nm). The substrates were further heated at 130° C. for 40 minutes to thermally cure the sealant and perform realignment treatment such that the liquid crystal transformed into an isotropic phase. The substrates were cooled down to room temperature, and thereby a 4D-RTN mode liquid crystal cell was obtained.

### Example 3-2

A 4D-RTN mode liquid crystal cell was produced as in Example 3-1, except that the amount of the monomer introduced was changed to 5 wt % of the amount of the solute (polysiloxane).

### Example 3-3

A 4D-RTN mode liquid crystal cell was produced as in Example 3-1, except that the amount of the monomer introduced was changed to 10 wt % of the amount of the solute (polysiloxane).

### Example 3-4

A 4D-RTN mode liquid crystal cell was produced as in Example 3-1, except that the amount of the monomer introduced was changed to 20 wt % of the amount of the solute (polysiloxane).

### Example 3-5

A 4D-RTN mode liquid crystal cell was produced as in Example 3-1, except that the amount of the monomer introduced was changed to 25 wt % of the amount of the solute (polysiloxane).

### Example 3-6

A 4D-RTN mode liquid crystal cell was produced as in Example 3-1, except that the amount of the monomer introduced was changed to 30 wt % of the amount of the solute (polysiloxane).

### Example 3-7

A 4D-RTN mode liquid crystal cell was produced as in Example 3-1, except that the amount of the monomer introduced was changed to 10 wt % of the amount of the solute (polysiloxane), and the liquid crystal material used was a negative liquid crystal material F (Δn=0.12, Δε=−2.9) having a Tni of 80° C. and a liquid crystal (nematic) phase temperature range of 100° C. or wider (specifically, wider than 100° C. and not wider than 105° C.) and containing no liquid crystal compound represented by the formula (D-1-1).

### Comparative Example 3-1

A 4D-RTN mode liquid crystal cell was produced as in Example 3-1, except that no monomer was introduced (the amount of the monomer introduced was 0 wt %).

The liquid crystal cells were subjected to the same evaluations as in Example 1-1 and the other examples. The results are shown in the following Table 3.

TABLE 3

| | | | Response | −20° C | Backlight | |
|---|---|---|---|---|---|---|
| | Monomer | Liquid | performance | storage | exposure | |
| | introduced | crystal | τr + τd (ms) | Crystal | VHR (%) | |
| | (wt %) | material | (25° C.) | deposition | 0 h | 1000 h |
| Com- | 0 | E | 18.3 | Occured | 99.2 | 92.7 |
| parative | | | | | | |
| Example | | | | | | |
| 3-1 | | | | | | |
| Example | 1 | E | 18.3 | Not | 99.2 | 97.5 |
| 3-1 | | | | occurred | | |
| Example | 5 | E | 18.4 | Not | 99.3 | 98.0 |
| 3-2 | | | | occurred | | |
| Example | 10 | E | 18.3 | Not | 99.2 | 98.0 |
| 3-3 | | | | occurred | | |
| Example | 20 | E | 18.4 | Not | 99.2 | 98.2 |
| 3-4 | | | | occurred | | |
| Example | 25 | E | 18.4 | Not | 99.3 | 98.2 |
| 3-5 | | | | occurred | | |
| Example | 30 | E | 18.4 | Not | 98.5 | 95.8 |
| 3-6 | | | | occurred | | |
| Example | 10 | F | 27.3 | Not | 99.3 | 98.0 |
| 3-7 | | | | occurred | | |

In the case where the alignment films contained no polymer of the monomer (Comparative Example 3-1), crystallization occurred in the −20° C. storage, and the VHR decreased to 93%-94% (exclusive of 94%) in the backlight exposure. This is presumably because the liquid crystal material contained 7 wt % or more of the liquid crystal compound represented by the formula (D-1-1), which crystalizes easily, and no polymer of the monomer represented by the formula (2-10), which blocks ultraviolet light.

In contrast, in Examples 3-1 to 3-5, crystallization did not occur in the −20° C. storage and the VHR did not decrease in the backlight aging. This is presumably because the azobenzene group in the formula (2-10) interacted with the liquid crystal molecules of the negative liquid crystal material to reduce crystal deposition and effectively blocked ultraviolet light from the backlight. In Example 3-6 in which the amount of the monomer introduced was 30 wt %, the high monomer content caused the alignment films to be white opaque and gave a low VHR in an early stage. Here, some monomers might have dissolved in the liquid crystal layer.

In Example 3-7 utilizing the liquid crystal material F, crystallization did not occur in the −20° C. storage and the VHR was high before and after the backlight exposure, but the response performance significantly deteriorated. This is presumably because the liquid crystal material F contained no liquid crystal compound represented by the formula (D-1-1) and thus had a high viscosity.

### Example 4-1

### (Preparation of Alignment Agent)

To a vertical alignment agent containing a polyamic acid that is represented by the following formula (H) and contains a vertical alignment functional group in a side chain was introduced a monomer containing an azobenzene group represented by the following formula (2-5). The solvent used was a mixed solvent of NMP and γ-butyrolactone. The amount of the monomer introduced was 1 wt % of the amount of the solute (polyamic acid).

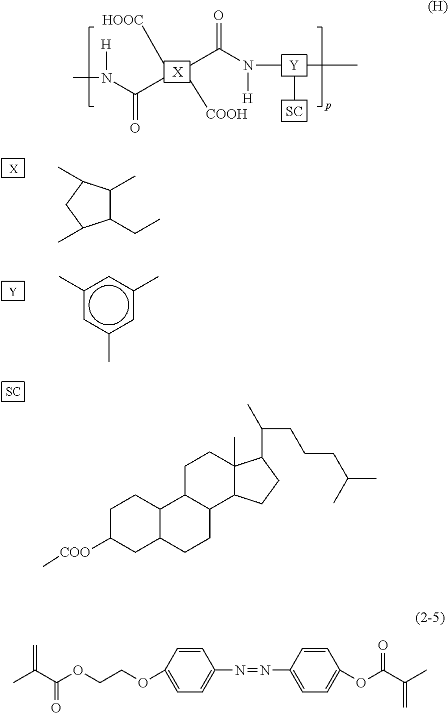

### (Production of Liquid Crystal Cell)

A pair of substrates each having an ITO electrode provided with slits was prepared. The vertical alignment agent was applied to each substrate, and pre-baked at 80° C. for two minutes, followed by post-baking at 200° C. for 40 minutes. To one of the substrates was applied an ultraviolet-curable, thermosetting sealant (Sekisui Chemical Co., Ltd.) in a predetermined pattern using a dispenser. Onto the predetermined positions of the other substrate was dropped a negative liquid crystal material E (Δn=0.12, Δε=−2.8) having a Tni of 70° C. and a liquid crystal (nematic) phase temperature range narrower than 100° C. (specifically, 90° C. to 95° C.). The liquid crystal material contains 7 wt % or more of a liquid crystal compound represented by the formula (D-1-1). The substrates were then bonded to each other in vacuum, and the sealant was cured by ultraviolet light (including ultraviolet light having a wavelength of 300 to 400 nm). The substrates were further heated at 130° C. for 40 minutes to thermally cure the sealant and perform realignment treatment such that the liquid crystal transformed into an isotropic phase. The substrates were cooled down to room temperature, and irradiated with ultraviolet light (black light FHF-32BLB from Toshiba Lighting & Technology Corporation) for 10 minutes to polymerize the monomer in the alignment film. Thereby, a vertical alignment mode liquid crystal cell was obtained.

### Example 4-2

A vertical alignment mode liquid crystal cell was produced as in Example 4-1, except that the amount of the monomer introduced was changed to 5 wt % of the amount of the solute (polyamic acid).

### Example 4-3

A vertical alignment mode liquid crystal cell was produced as in Example 4-1, except that the amount of the monomer introduced was changed to 10 wt % of the amount of the solute (polyamic acid).

### Example 4-4

A vertical alignment mode liquid crystal cell was produced as in Example 4-1, except that the amount of the monomer introduced was changed to 20 wt % of the amount of the solute (polyamic acid).

### Example 4-5

A vertical alignment mode liquid crystal cell was produced as in Example 4-1, except that the amount of the monomer introduced was changed to 25 wt % of the amount of the solute (polyamic acid).

### Example 4-6

A vertical alignment mode liquid crystal cell was produced as in Example 4-1, except that the amount of the monomer introduced was changed to 30 wt % of the amount of the solute (polyamic acid).

### Example 4-7

A vertical alignment mode liquid crystal cell was produced as in Example 4-1, except that the amount of the monomer introduced was changed to 10 wt % of the amount of the solute (polyamic acid), and the liquid crystal material used was a negative liquid crystal material F (Δn=0.12, Δε=−2.9) having a Tni of 80° C. and a liquid crystal (nematic) phase temperature range of 100° C. or wider (specifically, wider than 100° C. and not wider than 105° C.) and containing no liquid crystal compound represented by the formula (D-1-1).

### Comparative Example 4-1

A vertical alignment mode liquid crystal cell was produced as in Example 4-1, except that no monomer was introduced (the amount of the monomer introduced was 0 wt %).

The liquid crystal cells were subjected to the same evaluations as in Example 1-1 and the other examples. The results are shown in the following Table 4.

TABLE 4

| | | | Response | −20° C | Backlight | |
|---|---|---|---|---|---|---|
| | Monomer | Liquid | performance | storage | exposure | |
| | introduced | crystal | τr + τd (ms) | Crystal | VHR (%) | |
| | (wt %) | material | (25° C.) | deposition | 0 h | 1000 h |
| Com- | 0 | E | 23.2 | Occured | 99.4 | 96.8 |
| parative | | | | | | |
| Example | | | | | | |
| 4-1 | | | | | | |
| Example | 1 | E | 23.2 | Not | 99.5 | 99.1 |
| 4-1 | | | | occurred | | |
| Example | 5 | E | 23.2 | Not | 99.5 | 99.1 |
| 4-2 | | | | occurred | | |
| Example | 10 | E | 23.3 | Not | 99.5 | 99.1 |
| 4-3 | | | | occurred | | |
| Example | 20 | E | 23.3 | Not | 99.6 | 99.1 |
| 4-4 | | | | occurred | | |
| Example | 25 | E | 23.2 | Not | 99.5 | 99.2 |
| 4-5 | | | | occurred | | |
| Example | 30 | E | 23.3 | Not | 99.2 | 97.0 |
| 4-6 | | | | occurred | | |
| Example | 10 | F | 32.3 | Not | 99.5 | 99.2 |
| 4-7 | | | | occurred | | |

In the case where the alignment films contained no polymer of the monomer (Comparative Example 4-1), crystallization occurred in the −20° C. storage, and the VHR decreased to 97%-98% (exclusive of 98%) in the backlight exposure. This is presumably because the liquid crystal material contained 7 wt % or more of the liquid crystal compound represented by the formula (D-1-1), which crystalizes easily, and no polymer of the monomer represented by the formula (2-5), which blocks ultraviolet light.

In contrast, in Examples 4-1 to 4-5, crystallization did not occur in the −20° C. storage and the VHR did not decrease in the backlight aging. This is presumably because the azobenzene group in the formula (2-5) interacted with the liquid crystal molecules of the negative liquid crystal material to reduce crystal deposition and effectively blocked ultraviolet light from the backlight. In Example 4-6 in which the amount of the monomer introduced was 30 wt %, the high monomer content caused the alignment films to be white opaque and gave a low VHR in an early stage. Here, some monomers might have dissolved in the liquid crystal layer.

In Example 4-7 utilizing the liquid crystal material F, crystallization did not occur in the −20° C. storage and the VHR was high before and after the backlight exposure, but the response performance significantly deteriorated. This is presumably because the liquid crystal material F contained no liquid crystal compound represented by the formula (D-1-1) and thus had a high viscosity.

### (Additional Remarks)

One aspect of the present invention may be a liquid crystal display device including: a pair of substrates; a liquid crystal layer held between the substrates; and an alignment film disposed on a liquid crystal layer side surface of at least one of the substrates, the alignment film containing a first polymer and a second polymer, the first polymer having in its main chain at least one selected from a polyamic acid structure and a polyimide structure or a polysiloxane structure, the second polymer being obtained by polymerizing at least one monomer including at least one monomer represented by the following formula (1):

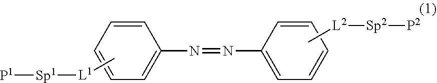

wherein P¹ and P² are the same as or different from each other, and each represent an acryloyloxy, methacryloyloxy, acryloylamino, methacryloylamino, vinyl, or vinyloxy group, Sp¹ and Sp² are the same as or different from each other, and each represent a C1-C10 linear, branched, or cyclic alkylene or alkenylene group, or a direct bond, L¹ and L² are the same as or different from each other, and each represent a —NH— group, a —N(CH₃)— group, a —O— group, a —S— group, or a direct bond, and at least one hydrogen atom in each phenylene group is optionally replaced.

In the above aspect of the liquid crystal display device, the liquid crystal display device can reduce crystallization of the liquid crystal material at low temperatures since it employs the alignment films containing the second polymer obtained by polymerizing at least one monomer represented by the formula (1). The liquid crystal display device also can maintain a favorable voltage holding ratio for a long period of time in exposure to the backlight illumination.

The at least one monomer represented by the formula (1) may include at least one monomer represented by any of the following formulas (2-1) to (2-17).

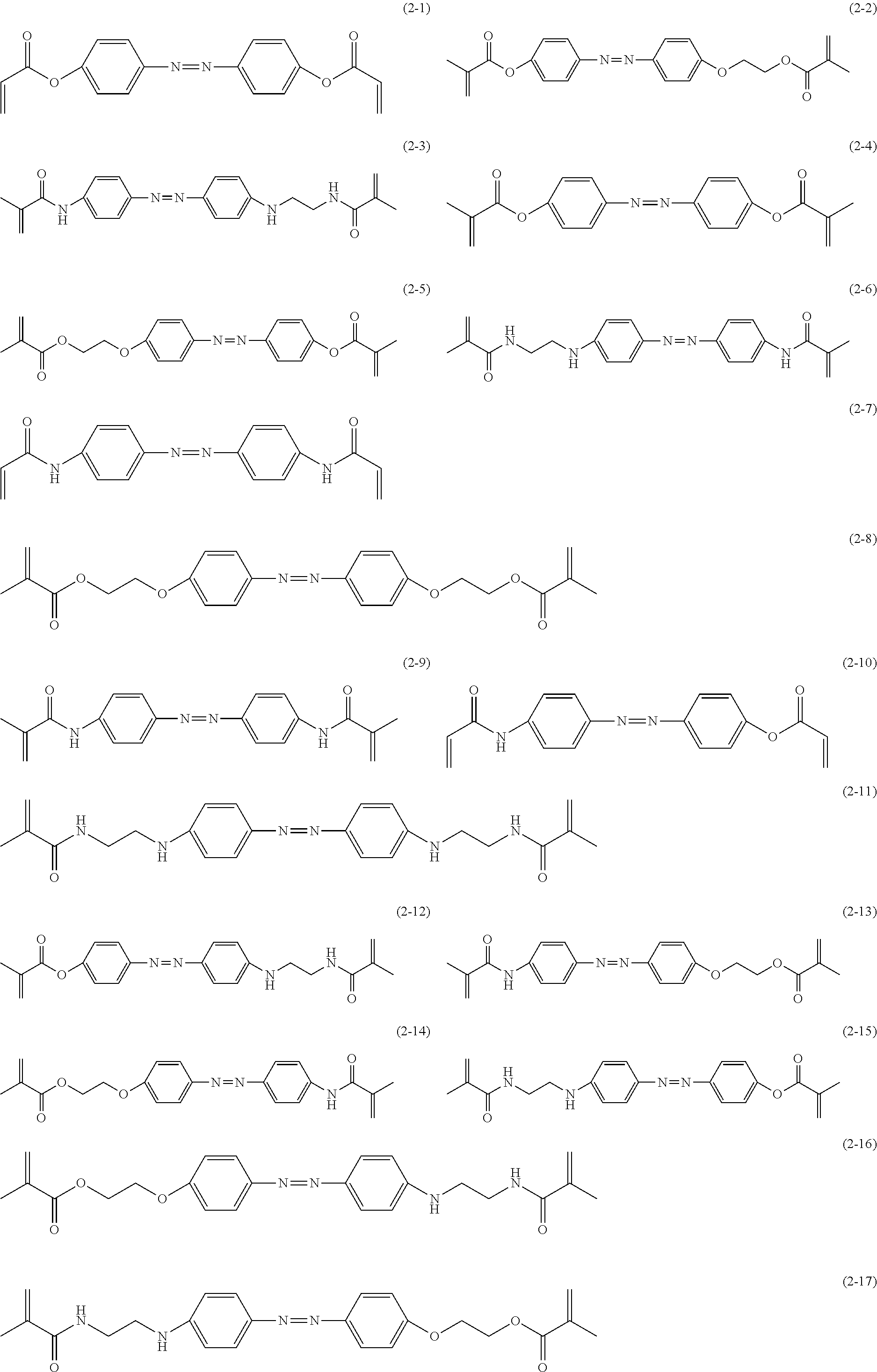

The first polymer may contain at least one photo-functional group selected from the group consisting of a cinnamate group, an azobenzene structure, a chalcone group, and a coumarin group, each of which may contain a substituent.

The alignment film may include a lower layer containing the first polymer and an upper layer disposed on a liquid crystal layer side of the lower layer and containing the second polymer.

The lower layer may be a photo-alignment layer.

The lower layer may be a vertical alignment layer.

The lower layer may be a horizontal alignment layer.

The liquid crystal layer preferably contains a liquid crystal material that has a nematic-isotropic phase transition temperature of 75° C. or lower and a nematic phase temperature range narrower than 100° C. Such a liquid crystal display device can reduce the viscosity of the liquid crystal material to enhance the response performance, but raises a concern about crystallization of the liquid crystal material at low temperatures. Still, the liquid crystal display device can reduce crystallization of the liquid crystal material at low temperatures since it employs the alignment films containing the second polymer obtained by polymerizing at least one monomer represented by the formula (1).

The liquid crystal layer may contain a liquid crystal material containing 7 wt % or more of a liquid crystal compound containing an alkenyl group.

The liquid crystal compound containing an alkenyl group may include at least one liquid crystal compound represented by any of the following formulas (D-1) to (D-4):

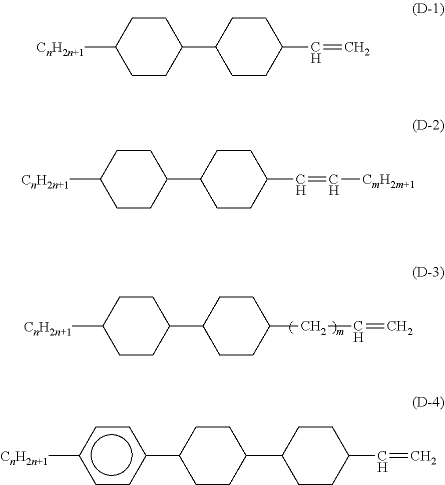

wherein m and n are the same as or different from each other, and each an integer of 1 to 6.

Another aspect of the present invention may be a method for manufacturing a liquid crystal display device, including: preparing a pair of substrates; forming an alignment film by applying to a surface of at least one of the substrates an alignment agent that contains a first polymer, having in its main chain at least one selected from a polyamic acid structure and a polyimide structure or a polysiloxane structure, and at least one monomer including at least one monomer represented by the following formula (1); and polymerizing, after the forming an alignment film, the at least one monomer including at least one monomer represented by the following formula (1) so as to form a second polymer,

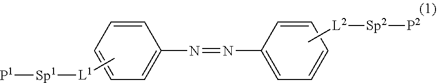

wherein P¹ and P² are the same as or different from each other, and each represent an acryloyloxy, methacryloyloxy, acryloylamino, methacryloylamino, vinyl, or vinyloxy group, Sp¹ and Sp² are the same as or different from each other, and each represent a C1-C10 linear, branched, or cyclic alkylene or alkenylene group, or a direct bond, L¹ and L² are the same as or different from each other, and each represent a —NH— group, a —N(CH₃)— group, a —O— group, a —S— group, or a direct bond, and at least one hydrogen atom in each phenylene group is optionally replaced.

The method for manufacturing a liquid crystal display device in the above aspect can reduce crystallization of the liquid crystal material at low temperatures since its polymerizing includes polymerizing at least one monomer represented by the formula (1) in the alignment films to form the second polymer. The method also can maintain a favorable voltage holding ratio for a long period of time in exposure to backlight illumination.

The at least one monomer represented by the formula (1) may include at least one monomer represented by any of the following formulas (2-1) to (2-17).

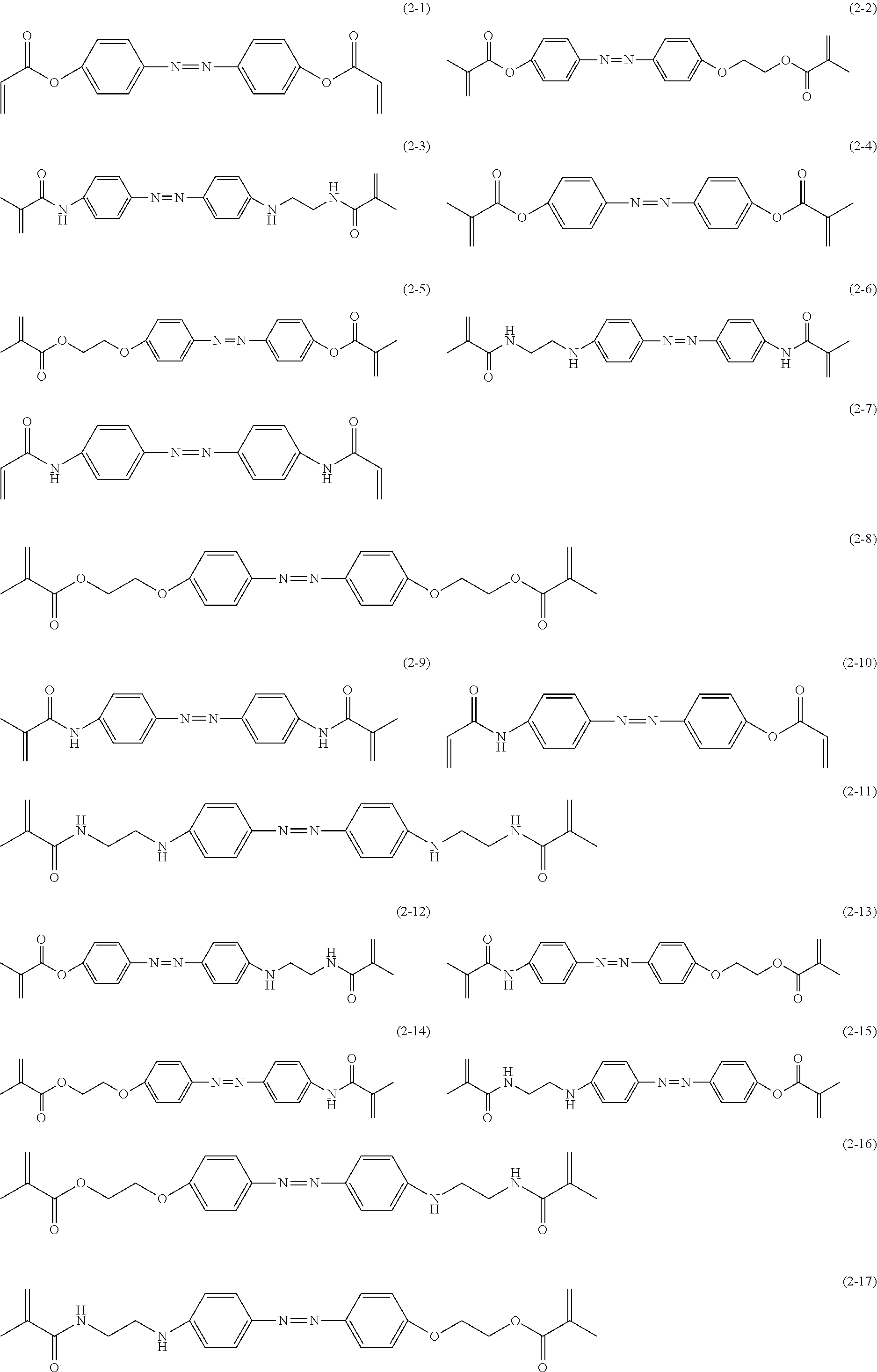

The polymerizing may include irradiating the alignment film with ultraviolet rays so as to polymerize the at least one monomer including at least one monomer represented by the formula (1).

The polymerizing may include irradiating the alignment film with ultraviolet rays so as to polymerize the at least one monomer including at least one monomer represented by the formula (1) and align the first polymer.

The method may further include forming a liquid crystal layer containing a liquid crystal material between the substrates on at least one of which the alignment film is formed, and transforming the liquid crystal material into an isotropic phase by heating the liquid crystal layer between the substrates, wherein the transforming is followed by the polymerizing, which includes irradiating the alignment film with ultraviolet rays so as to polymerize the at least one monomer including at least one monomer represented by the formula (1).

What is claimed is:

1. A liquid crystal display device comprising:
a pair of substrates;
a liquid crystal layer held between the substrates; and
an alignment film disposed on a liquid crystal layer side surface of at least one of the substrates,
the alignment film containing a first polymer and a second polymer, the first polymer having in its main chain at least one selected from a polyamic acid structure and a polyimide structure or a polysiloxane structure, the second polymer being obtained by polymerizing at least one monomer including at least one monomer represented by the following formula (1): 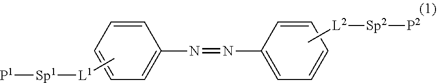
wherein P¹ and P² are the same as or different from each other, and each represent an acryloyloxy, methacryloyloxy, acryloylamino, methacryloylamino, vinyl, or vinyloxy group,
Sp¹ and Sp² are the same as or different from each other, and each represent a C1-C10 linear, branched, or cyclic alkylene or alkenylene group, or a direct bond,
L¹ and L² are the same as or different from each other, and each represent a —NH— group, a —N(CH₃)— group, a —O— group, a —S— group, or a direct bond, and
at least one hydrogen atom in each phenylene group is optionally replaced.

2. The liquid crystal display device according to claim 1,
wherein the at least one monomer represented by the formula (1) includes at least one monomer represented by any of the following formulas (2-1) to (2-17):

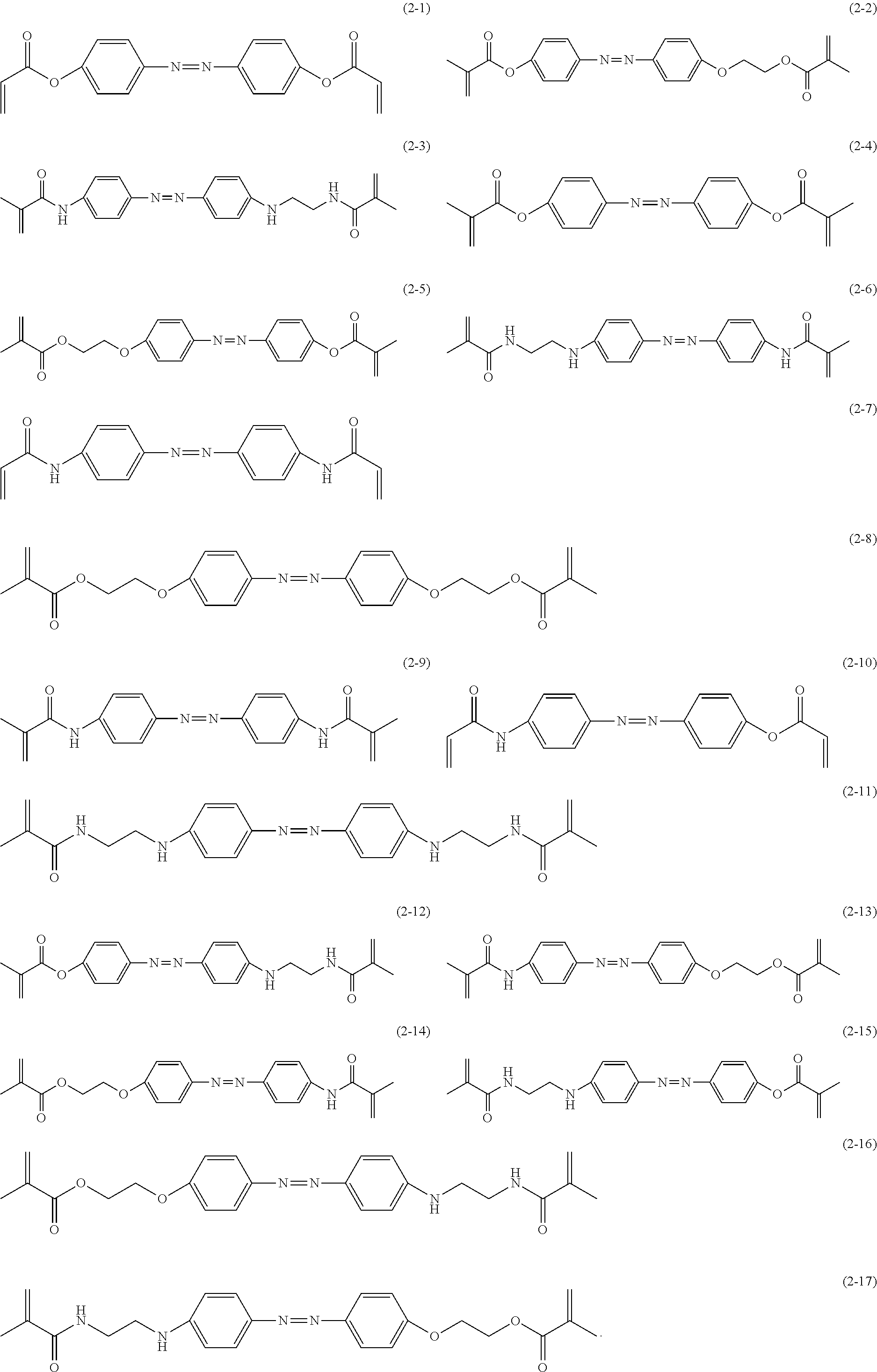

3. The liquid crystal display device according to claim 1,
wherein the first polymer contains at least one photo-functional group selected from the group consisting of a cinnamate group, an azobenzene structure, a chalcone group, and a coumarin group, each of which may contain a substituent.

4. The liquid crystal display device according to claim 1,
wherein the alignment film includes a lower layer containing the first polymer and an upper layer disposed on a liquid crystal layer side of the lower layer and containing the second polymer.

5. The liquid crystal display device according to claim 4,
wherein the lower layer is a photo-alignment layer.

6. The liquid crystal display device according to claim 4,
wherein the lower layer is a vertical alignment layer.

7. The liquid crystal display device according to claim 4,
wherein the lower layer is a horizontal alignment layer.

8. The liquid crystal display device according to claim 1,
wherein the liquid crystal layer contains a liquid crystal material that has a nematic-isotropic phase transition temperature of 75° C. or lower and a nematic phase temperature range narrower than 100° C.

9. The liquid crystal display device according to claim 1,
wherein the liquid crystal layer contains a liquid crystal material containing 7 wt % or more of a liquid crystal compound containing an alkenyl group.

10. The liquid crystal display device according to claim 9,
wherein the liquid crystal compound containing an alkenyl group includes at least one liquid crystal compound represented by any of the following formulas (D-1) to (D-4): 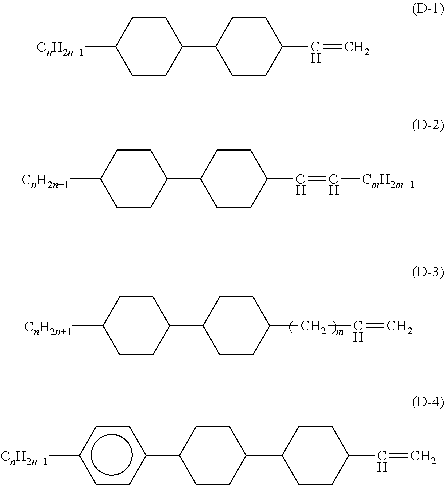
wherein m and n are the same as or different from each other, and each an integer of 1 to 6.

11. A method for manufacturing a liquid crystal display device, comprising:
preparing a pair of substrates;
forming an alignment film by applying to a surface of at least one of the substrates an alignment agent that contains a first polymer, having in its main chain at least one selected from a polyamic acid structure and a polyimide structure or a polysiloxane structure, and at least one monomer including at least one monomer represented by the following formula (1); and
polymerizing, after the forming an alignment film, the at least one monomer including at least one monomer represented by the following formula (1) so as to form a second polymer, 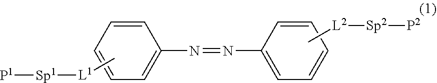
wherein P¹ and P² are the same as or different from each other, and each represent an acryloyloxy, methacryloyloxy, acryloylamino, methacryloylamino, vinyl, or vinyloxy group,
Sp¹ and Sp² are the same as or different from each other, and each represent a C1-C10 linear, branched, or cyclic alkylene or alkenylene group, or a direct bond,
L¹ and L² are the same as or different from each other, and each represent a —NH— group, a —N(CH₃)— group, a —O— group, a —S— group, or a direct bond, and
at least one hydrogen atom in each phenylene group is optionally replaced.

12. The method for manufacturing a liquid crystal display device according to claim 11,
wherein the at least one monomer represented by the formula (1) includes at least one monomer represented by any of the following formulas (2-1) to (2-17):

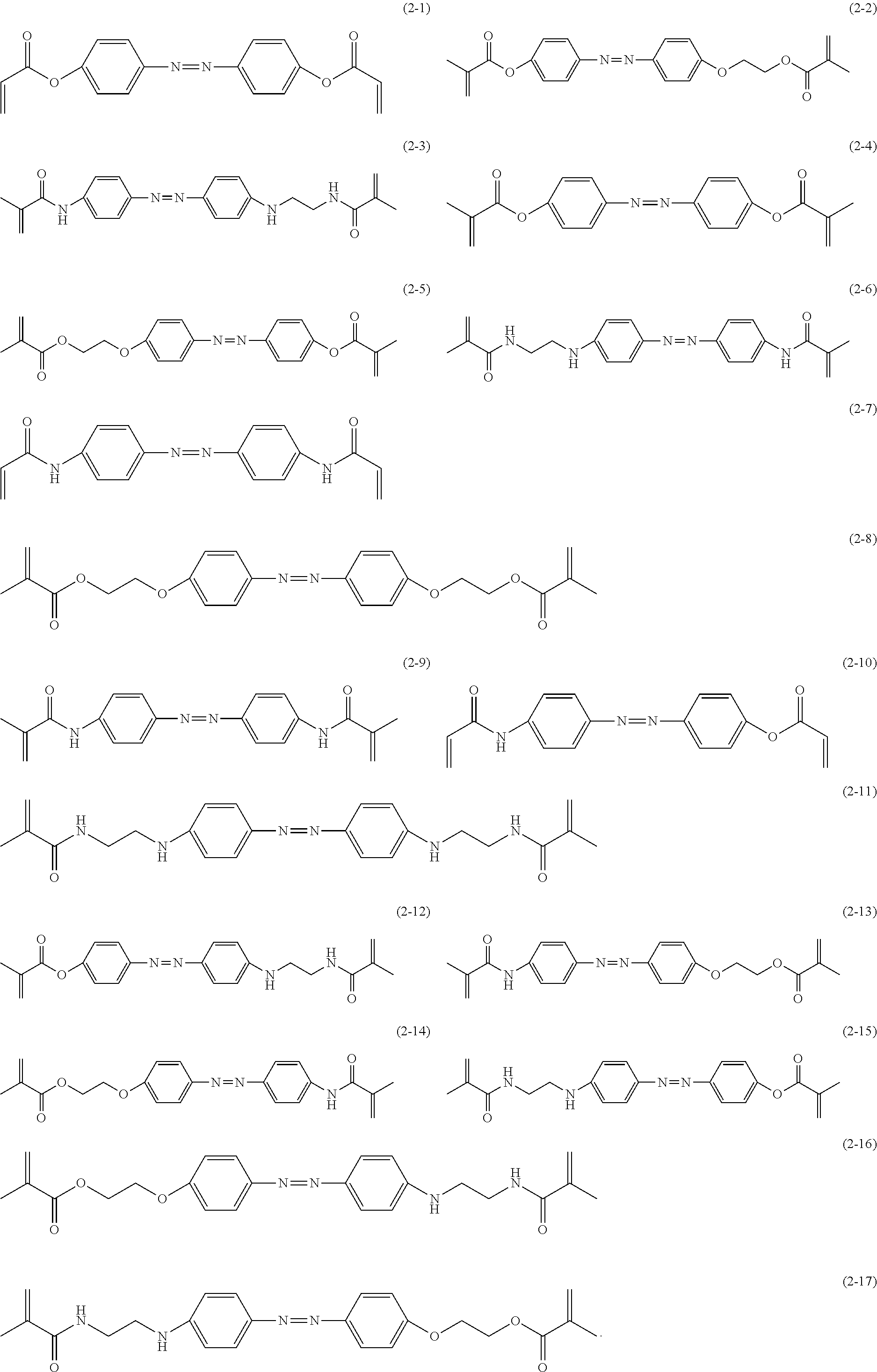

13. The method for manufacturing a liquid crystal display device according to claim 11,
wherein the polymerizing includes irradiating the alignment film with ultraviolet rays so as to polymerize the at least one monomer including at least one monomer represented by the formula (1).

14. The method for manufacturing a liquid crystal display device according to claim 13,
wherein the polymerizing includes irradiating the alignment film with ultraviolet rays so as to polymerize the at least one monomer including at least one monomer represented by the formula (1) and align the first polymer.

15. The method for manufacturing a liquid crystal display device according to claim 13, further comprising forming a liquid crystal layer containing a liquid crystal material between the substrates on at least one of which the alignment film is formed, and transforming the liquid crystal material into an isotropic phase by heating the liquid crystal layer between the substrates,
wherein the transforming is followed by the polymerizing, which includes irradiating the alignment film with ultraviolet rays so as to polymerize the at least one monomer including at least one monomer represented by the formula (1).
